(19) United States
(12) Patent Application Publication
(10) Pub. No.: US 2010/0225698 A1
(43) Pub. Date: Sep. 9, 2010

(54) PAGEWIDTH PRINTER WITH MOVABLE CAPPING MEMBER FOR PRINTHEAD

(75) Inventor: Kia Silverbrook, Balmain (AU)

Correspondence Address: SILVERBROOK RESEARCH PTY LTD, 393 DARLING STREET, BALMAIN, 2041, AU

(73) Assignee: Silverbrook Research Pty Ltd.

(21) Appl. No.: 12/785,469

(22) Filed: May 23, 2010

Related U.S. Application Data
(63) Continuation-in-part of application No. 12/422,868, filed on Apr. 13, 2009, now Pat. No. 7,726,771.
Application No. 12/422,868 is a continuation of application No. 11/743,655, filed on May 2, 2007, now Pat. No. 7,524,018.
Application No. 11/743,655 is a continuation of application No. 11/102,847, filed on Apr. 11, 2005, now Pat. No. 7,258,418.
Application No. 11/102,847 is a continuation of application No. 10/729,150, filed on Dec. 8, 2003, now Pat. No. 6,948,794.
Application No. 10/729,150 is a continuation of application No. 09/112,774, filed on Jul. 10, 1998, now abandoned.

(30) Foreign Application Priority Data
Jul. 15, 1997 (AU) PO7991
Dec. 12, 1997 (AU) PP0879

(51) Int. Cl. B41J 2/165

(52) U.S. Cl. 347/32

(57) ABSTRACT

A pagewidth inkjet printer that has a printhead with a nozzle surface and a surrounding surface that surrounds the nozzle surface, a platen that partially defines a media path extending passed the printhead, a capping member for sealing engagement with the surrounding surface, a solenoid for moving the capping member in a direction perpendicular to the longitudinal extent of the nozzle surface. During use, the printhead, the media path and the platen all remain fixed relative to each other, and the capping member is movable through the media path. Production efficiencies from lower precision assembly have particular significance for high volume products.

### CROSS REFERENCE TO RELATED APPLICATION

The present application is a continuation of U.S. application Ser. No. 12/422,868 filed Apr. 13, 2009, which is a continuation of U.S. application Ser. No. 11/743,655 filed on May 2, 2007, now issued U.S. Pat. No. 7,524,018, which is a continuation of U.S. application Ser. No. 11/102,847 filed Apr. 11, 2005, now issued U.S. Pat. No. 7,258,418, which is a continuation of U.S. application Ser. No. 10/729,150 filed Dec. 8, 2003, now issued U.S. Pat. No. 6,948,794, which is a continuation of U.S. application Ser. No. 09/112,774 filed on Jul. 10, 1998, the entire contents of which are herein incorporated by reference.

### FIELD OF THE INVENTION

The present invention relates substantially to the concept of a disposable camera having instant printing capabilities and in particular, discloses a printhead re-capping assembly for a digital camera system.

### BACKGROUND OF THE INVENTION

Recently, the concept of a “single use” disposable camera has become an increasingly popular consumer item. Disposable camera systems presently on the market normally include an internal film roll and a simplified gearing mechanism for traversing the film roll across an imaging system including a shutter and lensing system. The user, after utilizing a single film roll returns the camera system to a film development center for processing. The film roll is taken out of the camera system and processed and the prints returned to the user. The camera system can then be re-manufactured through the insertion of a new film roll into the camera system, the replacement of any worn or wearable parts and the re-packaging of the camera system in accordance with requirements. In this way, the concept of a single use “disposable” camera is provided to the consumer.

Recently, a camera system has been proposed by the present applicant which provides for a handheld camera device having an internal print head, image sensor and processing means such that images sense by the image sensing means, are processed by the processing means and adapted to be instantly printed out by the printing means on demand. The proposed camera system further discloses a system of internal “print rolls” carrying print media such as film on to which images are to be printed in addition to ink to supplying the printing means for the printing process. The print roll is further disclosed to be detachable and replaceable within the camera system.

Unfortunately, such a system is likely to only be constructed at a substantial cost and it would be desirable to provide for a more inexpensive form of instant camera system which maintains a substantial number of the quality aspects of the aforementioned arrangement.

It would be further advantageous to provide for the effective interconnection of the sub components of a camera system.

### SUMMARY OF THE INVENTION

According to a first aspect of the invention, there is provided a printhead re-capping assembly for a printer having a chassis, a platen assembly and a pagewidth printhead operatively mounted on the chassis to carry out a printing operation on print media passing over the platen assembly, the re-capping assembly comprising

a base structure that is mounted on the chassis;

at least one static solenoid that is mounted on the base structure and that is connected to an electrical power supply of the printer;

a support member that is actuable by the solenoid to be movable with respect to the chassis between an operative position and an inoperative position; and

a printhead capping member that is mounted on the support member such that when the support member is in the operative position, the capping member engages the printhead to cap the printhead and when the support member is in the inoperative position, the capping member is disengaged from the printhead.

The support member may be configured to be normally in the operative position and to move into the inoperative position when the solenoid is energized by the electrical power supply.

A biasing mechanism may be engaged with the support member to bias the support member into the operative position when the solenoid is de-energized.

The base structure and the solenoid may both be elongate to correspond with a length of the printhead.

The support member may also be elongate and may correspond generally with the printhead.

The capping member may include a length of sponge that is dimensioned to cover the printhead when the support member is displaced into its operative position.

A sealing member may be positioned on the support member to bound the length of sponge such that, when the length of sponge caps the printhead, the sealing member serves to seal a region about the printhead.

In accordance with a second aspect of the present invention, there is provided in a camera system comprising: an image sensor device for sensing an image; a processing means for processing the sensed image; a print media supply means for the supply of print media to a print head; a print head for printing the sensed image on the print media stored internally to the camera system; a portable power supply interconnected to the print head, the sensor and the processing means; and a guillotine mechanism located between the print media supply means and the print head and adapted to cut the print media into sheets of a predetermined size.

Further, preferably, the guillotine mechanism is detachable from the camera system. The guillotine mechanism can be attached to the print media supply means and is detachable from the camera system with the print media supply means. The guillotine mechanism can be mounted on a platen unit below the print head.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates a front perspective view of the assembled camera of the preferred embodiment;

FIG. 2 illustrates a rear perspective view, partly exploded, of the preferred embodiment;

FIG. 3 is a perspective view of the chassis of the preferred embodiment;

FIG. 4 is a perspective view of the chassis illustrating mounting of electric motors;

FIG. 5 is an exploded perspective of the ink supply mechanism of the preferred embodiment;

FIG. 6 is rear perspective of the assembled form of the ink supply mechanism of the preferred embodiment;

FIG. 7 is a front perspective view of the assembled form of the ink supply mechanism of the preferred embodiment;

FIG. 8 is an exploded perspective view of the platen unit of the preferred embodiment;

FIG. 9 is a perspective view of the assembled form of the platen unit;

FIG. 10 is also a perspective view of the assembled form of the platen unit;

FIG. 11 is an exploded perspective view of the printhead recapping mechanism of the preferred embodiment;

FIG. 12 is a close up exploded perspective of the recapping mechanism of the preferred embodiment;

FIG. 13 is an exploded perspective of the ink supply cartridge of the preferred embodiment;

FIG. 14 is a close up perspective, view partly in section, of the internal portions of the ink supply cartridge in an assembled form;

FIG. 15 is a schematic block diagram of one form of integrated circuit layer of the image capture and processing integrated circuit of the preferred embodiment;

FIG. 16 is an exploded view perspective illustrating the assembly process of the preferred embodiment;

FIG. 17 illustrates a front exploded perspective view of the assembly process of the preferred embodiment;

FIG. 18 illustrates a perspective view of the assembly process of the preferred embodiment;

FIG. 19 illustrates a perspective view of the assembly process of the preferred embodiment;

FIG. 20 is a perspective view illustrating the insertion of the platen unit in the preferred embodiment;

FIG. 21 illustrates the interconnection of the electrical components of the preferred embodiment;

FIG. 22 illustrates the process of assembling the preferred embodiment; and

FIG. 23 is a perspective view further illustrating the assembly process of the preferred embodiment.

### DESCRIPTION OF PREFERRED AND OTHER EMBODIMENTS

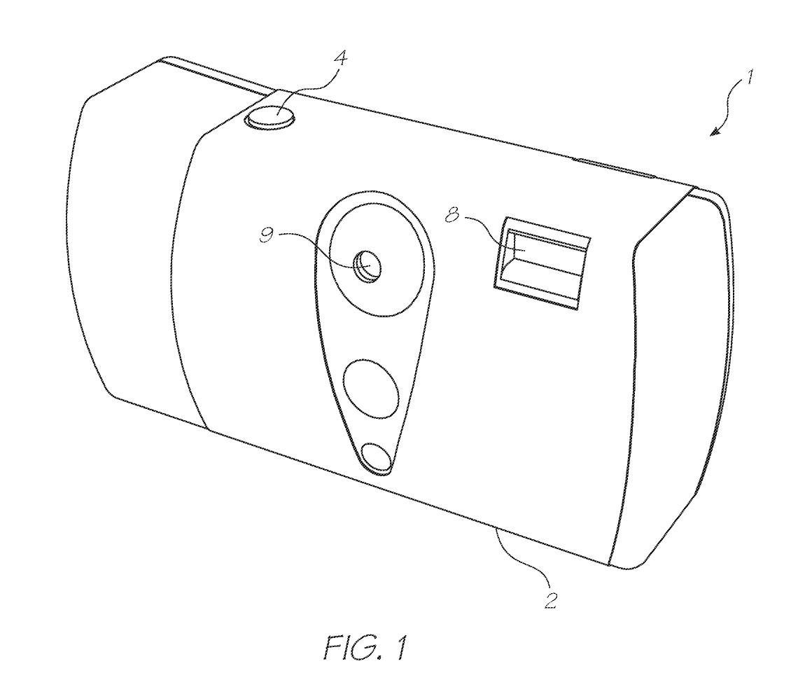

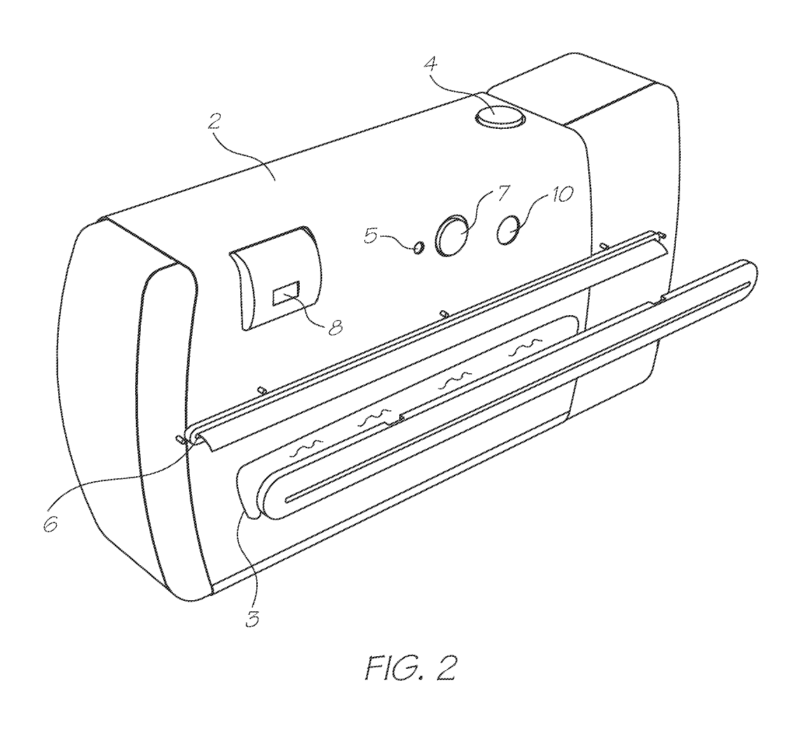

Turning initially simultaneously to FIG. 1 and FIG. 2 there are illustrated perspective views of an assembled camera constructed in accordance with the preferred embodiment with FIG. 1 showing a front perspective view and FIG. 2 showing a rear perspective view. The camera 1 includes a paper or plastic film jacket 2 which can include simplified instructions 3 for the operation of the camera system 1. The camera system 1 includes a first “take” button 4 which is depressed to capture an image. The captured image is output via output slot 6. A further copy of the image can be obtained through depressing a second “printer copy” button 7 whilst an LED light 5 is illuminated. The camera system also provides the usual view finder 8 in addition to a CCD image capture/lensing system 9.

The camera system 1 provides for a standard number of output prints after which the camera system 1 ceases to function. A prints left indicator slot 10 is provided to indicate the number of remaining prints. A refund scheme at the point of purchase is assumed to be operational for the return of used camera systems for recycling.

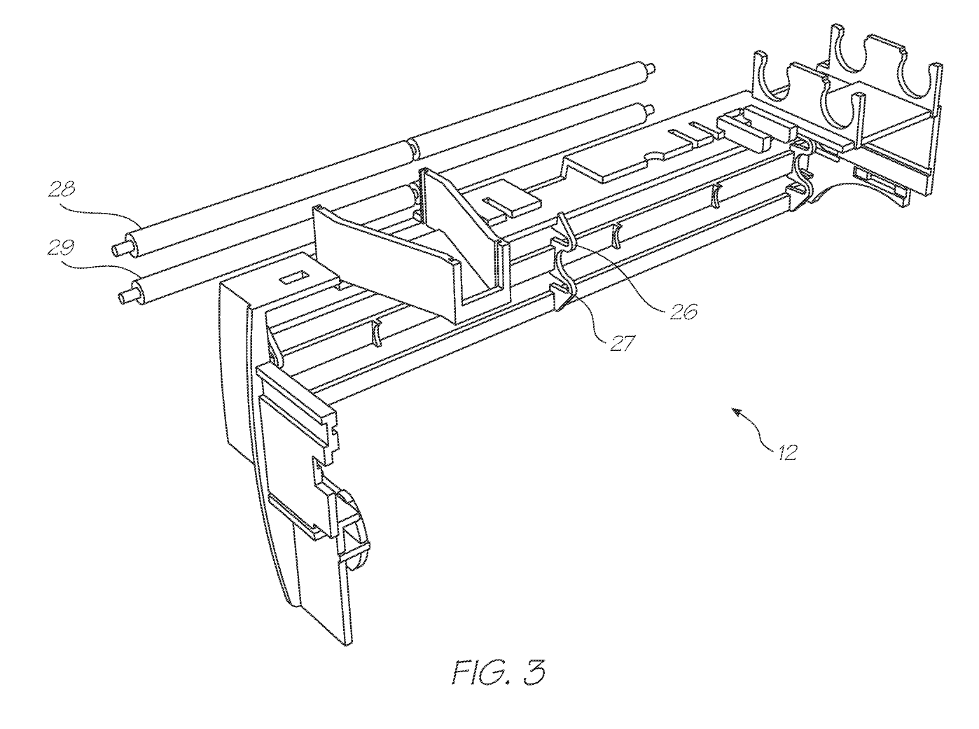

Turning now to FIG. 3, the assembly of the camera system is based around an internal chassis 12 which can be a plastic injection molded part. A pair of paper pinch rollers 28, 29 utilized for decurling are snap fitted into corresponding frame holes eg. 26, 27.

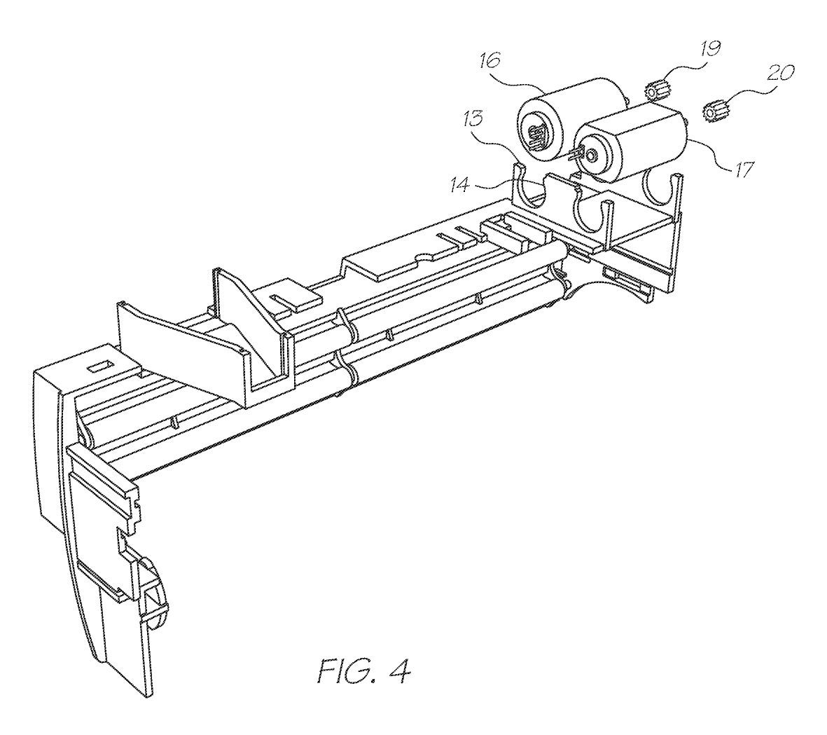

As shown in FIG. 4, the chassis 12 includes a series of mutually opposed prongs eg. 13, 14 into which is snapped fitted a series of electric motors 16, 17. The electric motors 16, 17 can be entirely standard with the motor 16 being of a stepper motor type. The motor 16, 17 include cogs 19, 20 for driving a series of gear wheels. A first set of gear wheels is provided for controlling a paper cutter mechanism and a second set is provided for controlling print roll movement.

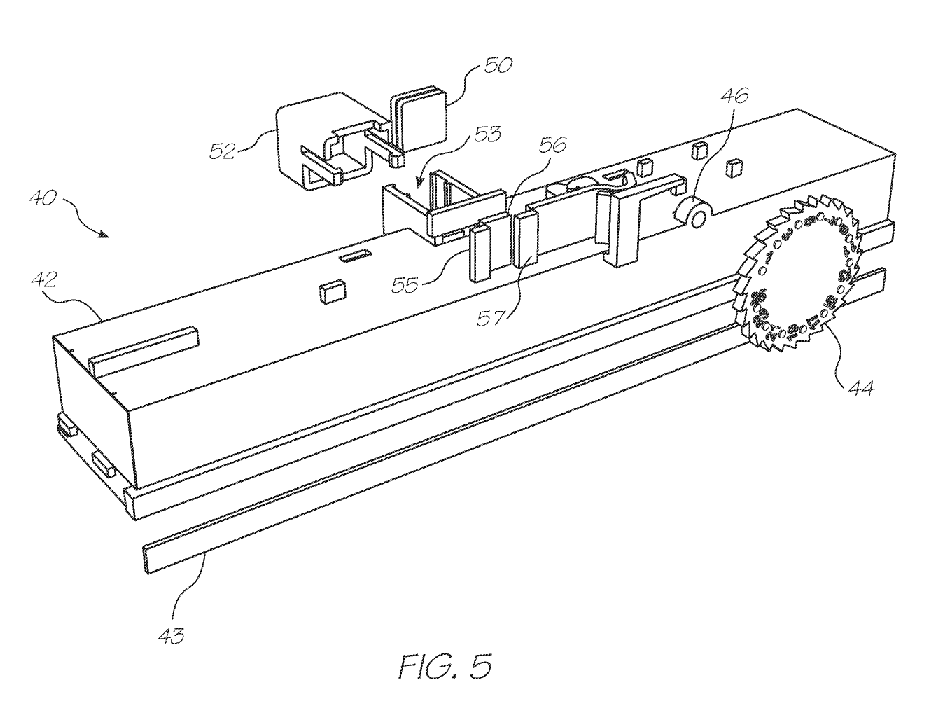

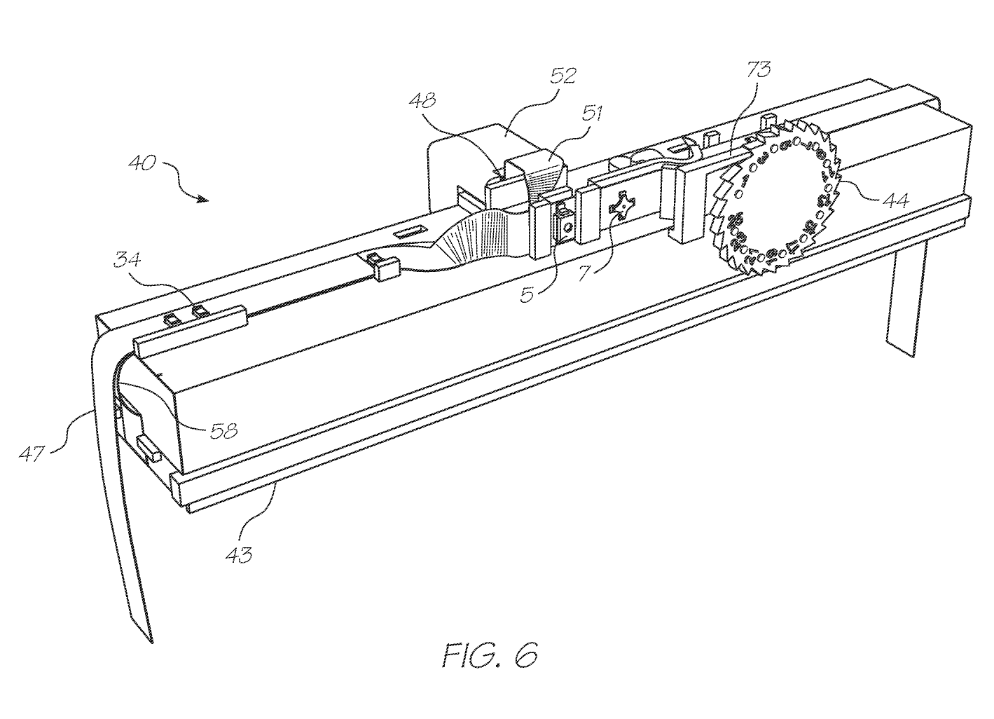

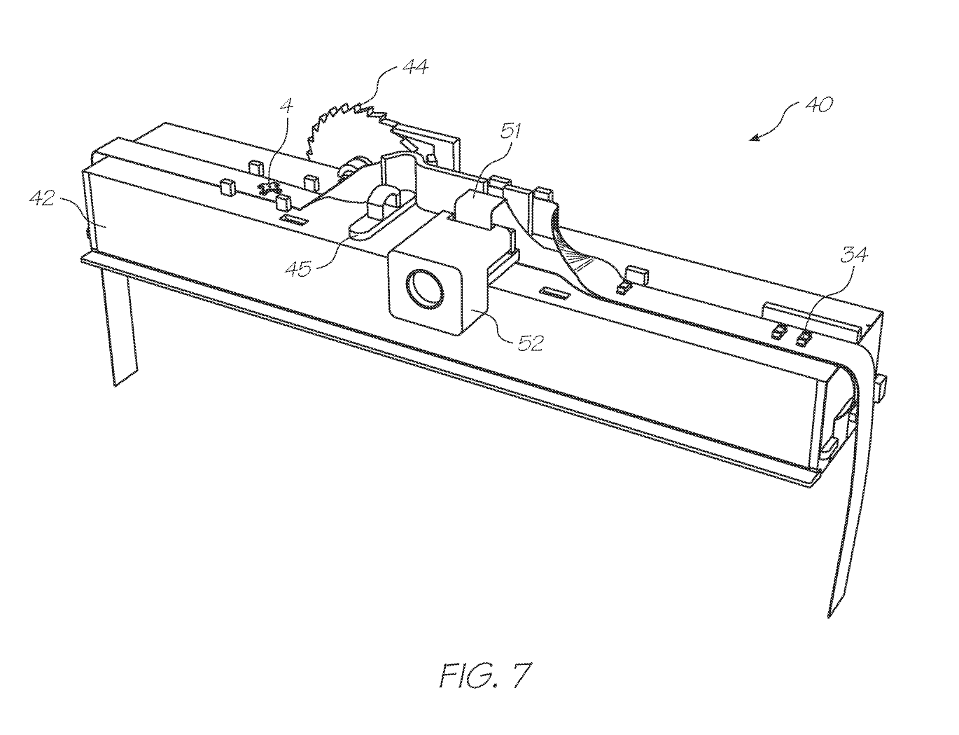

Turning next to FIGS. 5 to 7, there is illustrated an ink supply mechanism 40 utilized in the camera system. FIG. 5 illustrates a back exploded perspective view, FIG. 6 illustrates a back assembled view and FIG. 7 illustrates a front assembled view. The ink supply mechanism 40 is based around an ink supply cartridge 42 which contains printer ink and a print head mechanism for printing out pictures on demand. The ink supply cartridge 42 includes a side aluminium strip 43 which is provided as a shear strip to assist in cutting images from a paper roll.

A dial mechanism 44 is provided for indicating the number of “prints left”. The dial mechanism 44 is snap fitted through a corresponding mating portion 46 so as to be freely rotatable.

As shown in FIG. 6, the mechanism 40 includes a flexible PCB strip 47 which interconnects with the print head and provides for control of the print head. The interconnection between the Flex PCB strip and an image sensor and print head integrated circuit can be via Tape Automated Bonding (TAB) Strips 51, 58. A moulded aspherical lens and aperture shim 50 (FIG. 5) is also provided for imaging an image onto the surface of the image sensor integrated circuit normally located within cavity 53 and a light box module or hood 52 is provided for snap fitting over the cavity 53 so as to provide for proper light control. A series of decoupling capacitors eg. 34 can also be provided. Further a plug 45 (FIG. 7) is provided for re-plugging ink holes after refilling. A series of guide prongs eg. 55-57 are further provided for guiding the flexible PCB strip 47.

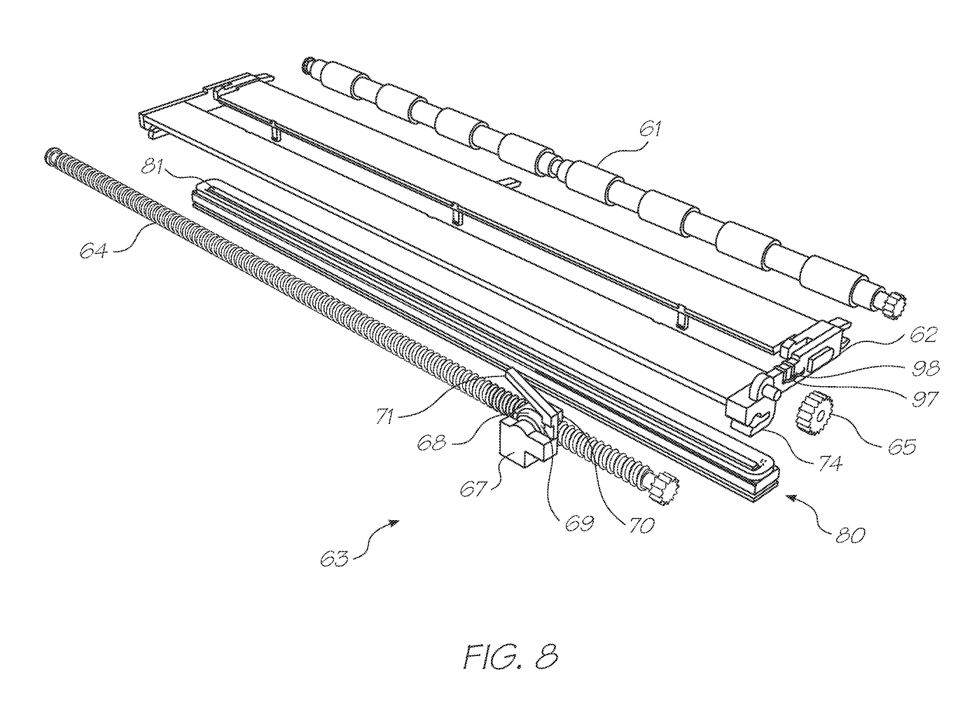

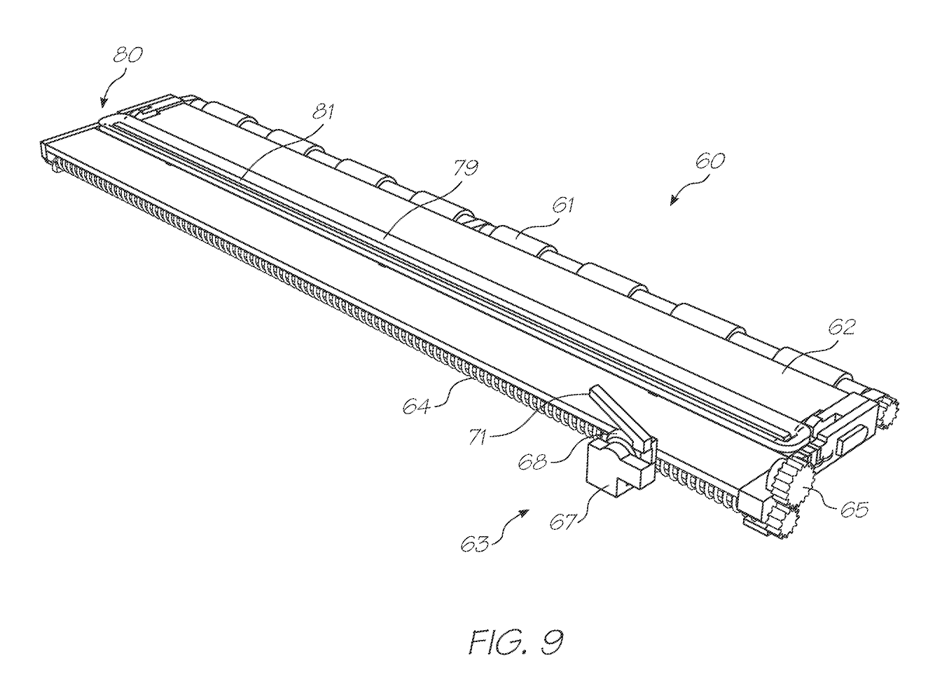

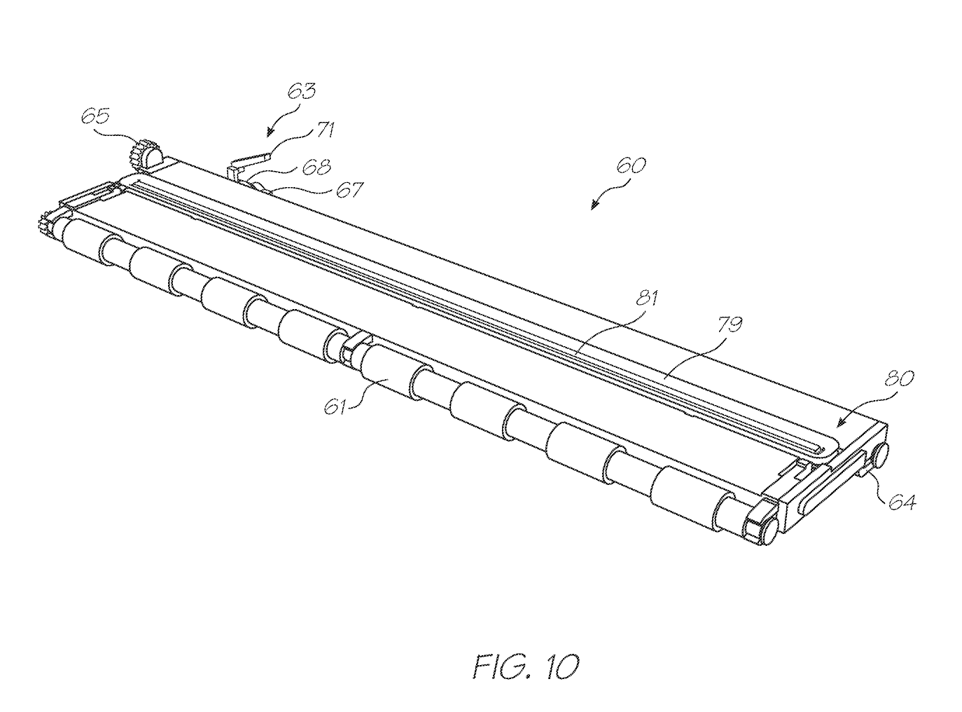

The ink supply mechanism 40 interacts with a platen unit 60 which guides print media under a printhead located in the ink supply mechanism. FIG. 8 shows an exploded view of the platen unit 60, while FIGS. 9 and 10 show assembled views of the platen unit. The platen unit 60 includes a first pinch roller 61 which is snap fitted to one side of a platen base 62. Attached to a second side of the platen base 62 is a cutting mechanism 63 which traverses the platen unit 60 by means of a rod 64 having a screw thread which is rotated by means of cogged wheel 65 which is also fitted to the platen base 62. The screw threaded rod 64 mounts a block 67 which includes a cutting wheel 68 fastened via a fastener 69. Also mounted to the block 67 is a counter actuator which includes a pawl 71. The pawl 71 acts to rotate the dial mechanism 44 of FIG. 6 upon the return traversal of the cutting wheel. As shown previously in FIG. 6, the dial mechanism 44 includes a cogged surface which interacts with pawl 71, thereby maintaining a count of the number of photographs by means of numbers embossed on the surface of dial mechanism 44. The cutting mechanism 63 is inserted into the platen base 62 by means of a snap fit via clips 74.

The platen unit 60 includes an internal recapping mechanism 80 for recapping the print head when not in use. The recapping mechanism 80 includes a sponge portion 81 and is operated via a solenoid coil so as to provide for recapping of the print head. In the preferred embodiment, there is provided an inexpensive form of printhead re-capping mechanism provided for incorporation into a handheld camera system so as to provide for printhead re-capping of an inkjet printhead.

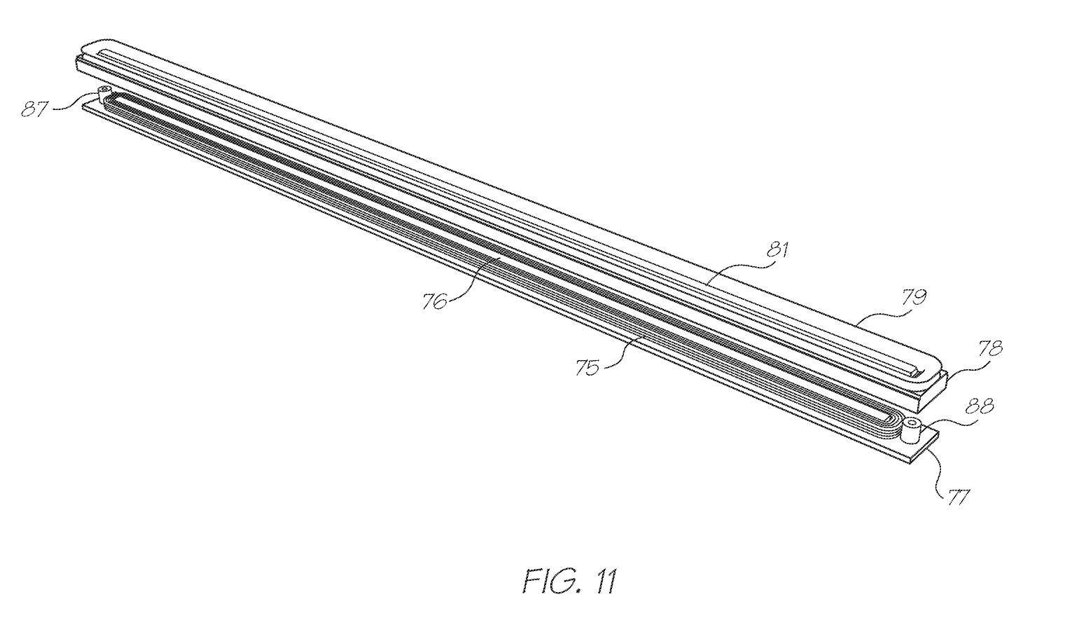

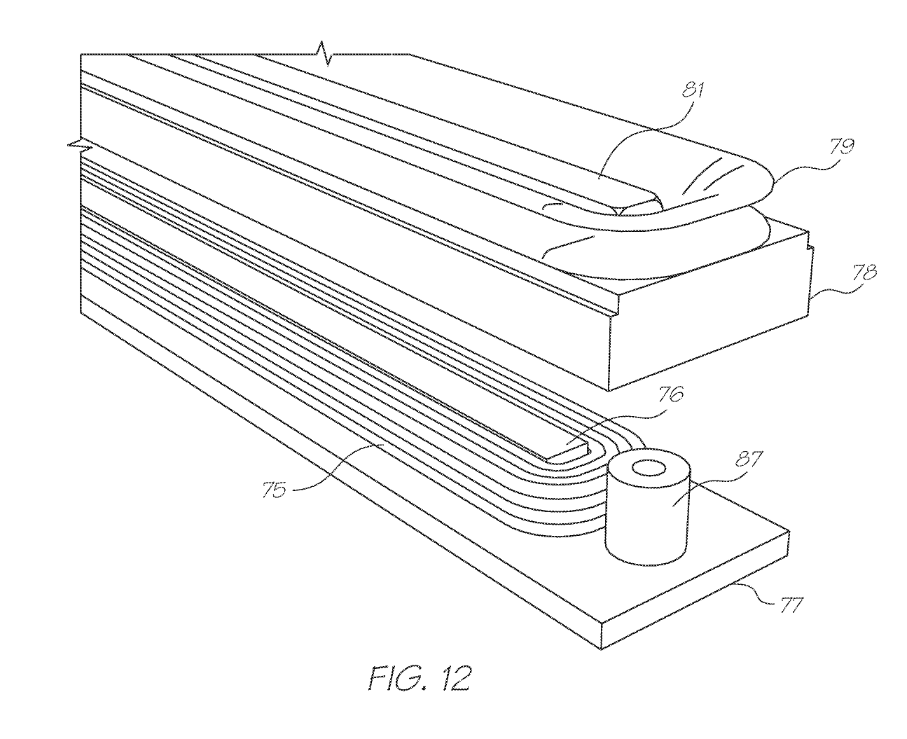

FIG. 11 illustrates an exploded view of the recapping mechanism whilst FIG. 12 illustrates a close up of the end portion thereof. The re-capping mechanism 80 is structured around a solenoid including a 16 turn coil 75 which can comprise insulated wire. The coil 75 is turned around a first stationery solenoid arm 76 which is mounted on a bottom surface of the platen base 62 (FIG. 8) and includes a post portion 77 to magnify effectiveness of operation. The arm 76 can comprise a ferrous material.

A second moveable arm 78 of the solenoid actuator is also provided. The arm 78 is moveable and is also made of ferrous material. Mounted on the arm is a sponge portion surrounded by an elastomer strip 79. The elastomer strip 79 is of a generally arcuate cross-section and act as a leaf spring against the surface of the printhead ink supply cartridge 42 (FIG. 5) so as to provide for a seal against the surface of the printhead ink supply cartridge 42. In the quiescent position an elastomer spring unit 87, 88 acts to resiliently deform the elastomer seal 79 against the surface of the ink supply unit 42.

When it is desired to operate the printhead unit, upon the insertion of paper, the solenoid coil 75 is activated so as to cause the arm 78 to move down to be adjacent to the end plate 76. The arm 78 is held against end plate 76 while the printhead is printing by means of a small “keeper current” in coil 75. Simulation results indicate that the keeper current can be significantly less than the actuation current. Subsequently, after photo printing, the paper is guillotined by the cutting mechanism 63 of FIG. 8 acting against Aluminium Strip 43, and rewound so as to clear the area of the re-capping mechanism 80. Subsequently, the current is turned off and springs 87, 88 return the arm 78 so that the elastomer seal is again resting against the printhead ink supply cartridge.

It can be seen that the preferred embodiment provides for a simple and inexpensive means of re-capping a printhead through the utilisation of a solenoid type device having a long rectangular form. Further, the preferred embodiment utilises minimal power in that currents are only required whilst the device is operational and additionally, only a low keeper current is required whilst the printhead is printing.

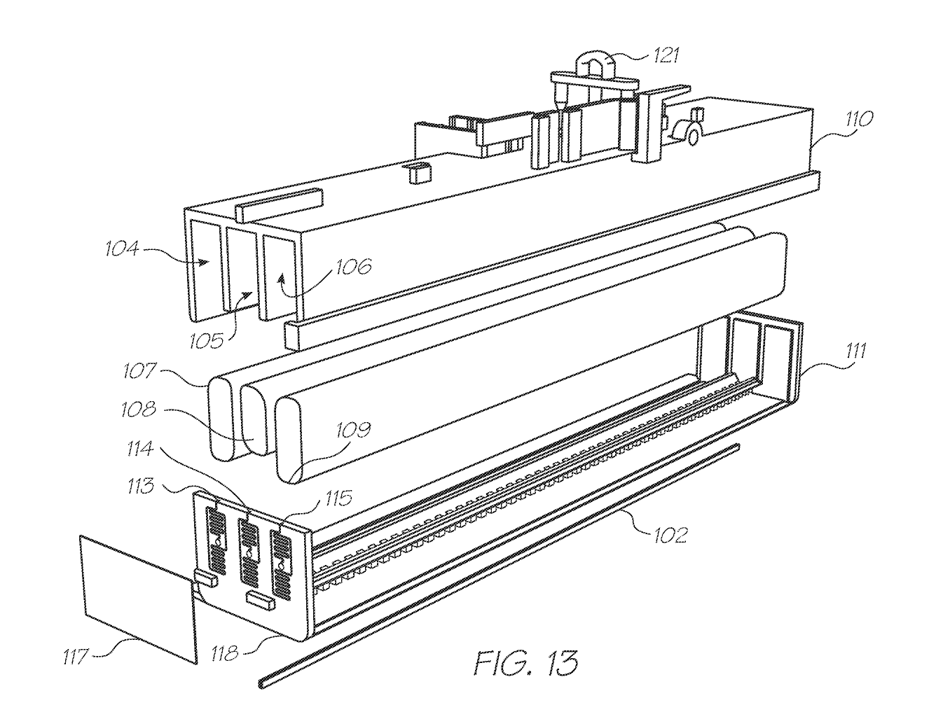

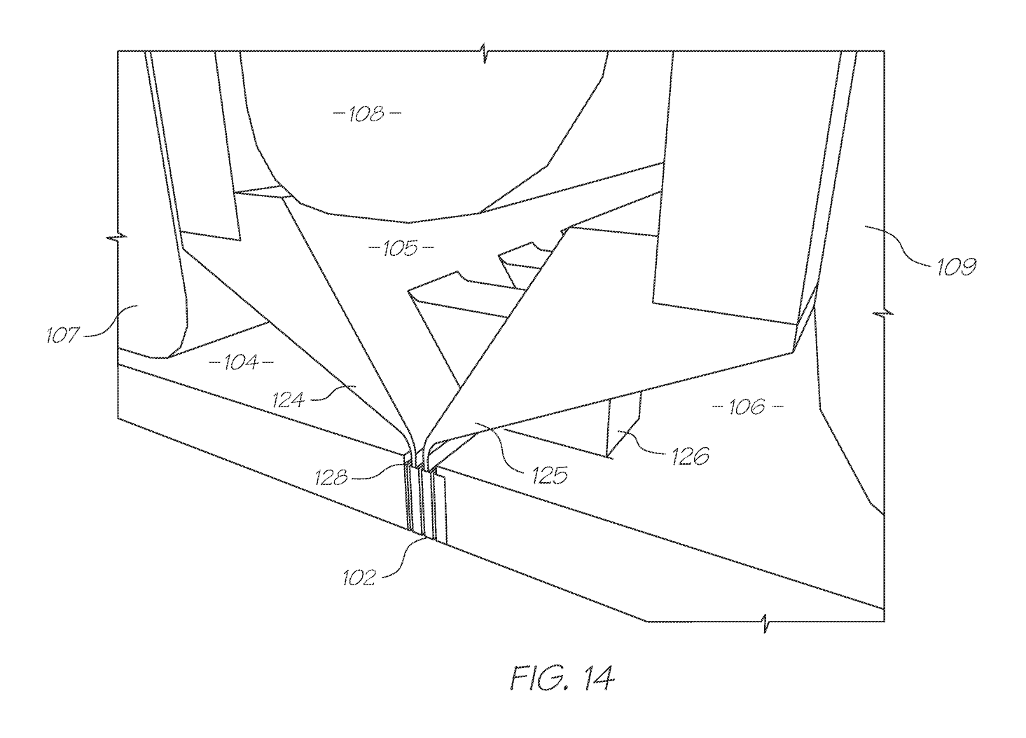

Turning next to FIGS. 13 and 14, FIG. 13 illustrates an exploded perspective of the ink supply cartridge 42 whilst FIG. 14 illustrates a close up sectional view of a bottom of the ink supply cartridge with the printhead unit in place. The ink supply cartridge 42 is based around a pagewidth printhead 102 which comprises a long slither of silicon having a series of holes etched on the back surface for the supply of ink to a front surface of the silicon wafer for subsequent ejection via a micro electro mechanical system. The form of ejection can be many different forms such as those set out in the tables below.

Of course, many other inkjet technologies, as referred to the attached tables below, can also be utilised when constructing a printhead unit 102. The fundamental requirement of the ink supply cartridge 42 is the supply of ink to a series of colour channels etched through the back surface of the printhead 102. In the description of the preferred embodiment, it is assumed that a three colour printing process is to be utilised so as to provide full colour picture output. Hence, the print supply unit includes three ink supply reservoirs being a cyan reservoir 104, a magenta reservoir 105 and a yellow reservoir 106. Each of these reservoirs is required to store ink and includes a corresponding sponge type material 107-109 which assists in stabilising ink within the corresponding ink channel and inhibiting the ink from sloshing back and forth when the printhead is utilised in a handheld camera system. The reservoirs 104, 105, 106 are formed through the mating of first exterior plastic piece 110 and a second base piece 111.

At a first end 118 of the base piece 111 a series of air inlet 113-115 are provided. Each air inlet leads to a corresponding winding channel which is hydrophobically treated so as to act as an ink repellent and therefore repel any ink that may flow along the air inlet channel. The air inlet channel further takes a convoluted path assisting in resisting any ink flow out of the chambers 104-106. An adhesive tape portion 117 is provided for sealing the channels within end portion 118.

At the top end, there is included a series of refill holes (not shown) for refilling corresponding ink supply chambers 104, 105, 106. A plug 121 is provided for sealing the refill holes.

Turning now to FIG. 14, there is illustrated a close up perspective view, partly in section through the ink supply cartridge 42 of FIG. 13 when formed as a unit. The ink supply cartridge includes the three colour ink reservoirs 104, 105, 106 which supply ink to different portions of the back surface of printhead 102 which includes a series of apertures 128 defined therein for carriage of the ink to the front surface.

The ink supply cartridge 42 includes two guide walls 124, 125 which separate the various ink chambers and are tapered into an end portion abutting the surface of the printhead 102. The guide walls 124, 125 are further mechanically supported by block portions eg. 126 which are placed at regular intervals along the length of the ink supply unit. The block portions 126 leave space at portions close to the back of printhead 102 for the flow of ink around the back surface thereof.

The ink supply unit is preferably formed from a multi-part plastic injection mould and the mould pieces eg. 110, 111 (FIG. 13) snap together around the sponge pieces 107, 109. Subsequently, a syringe type device can be inserted in the ink refill holes and the ink reservoirs filled with ink with the air flowing out of the air outlets 113-115. Subsequently, the adhesive tape portion 117 and plug 121 are attached and the printhead tested for operation capabilities. Subsequently, the ink supply cartridge 42 can be readily removed for refilling by means of removing the ink supply cartridge, performing a washing cycle, and then utilising the holes for the insertion of a refill syringe filled with ink for refilling the ink chamber before returning the ink supply cartridge 42 to a camera.

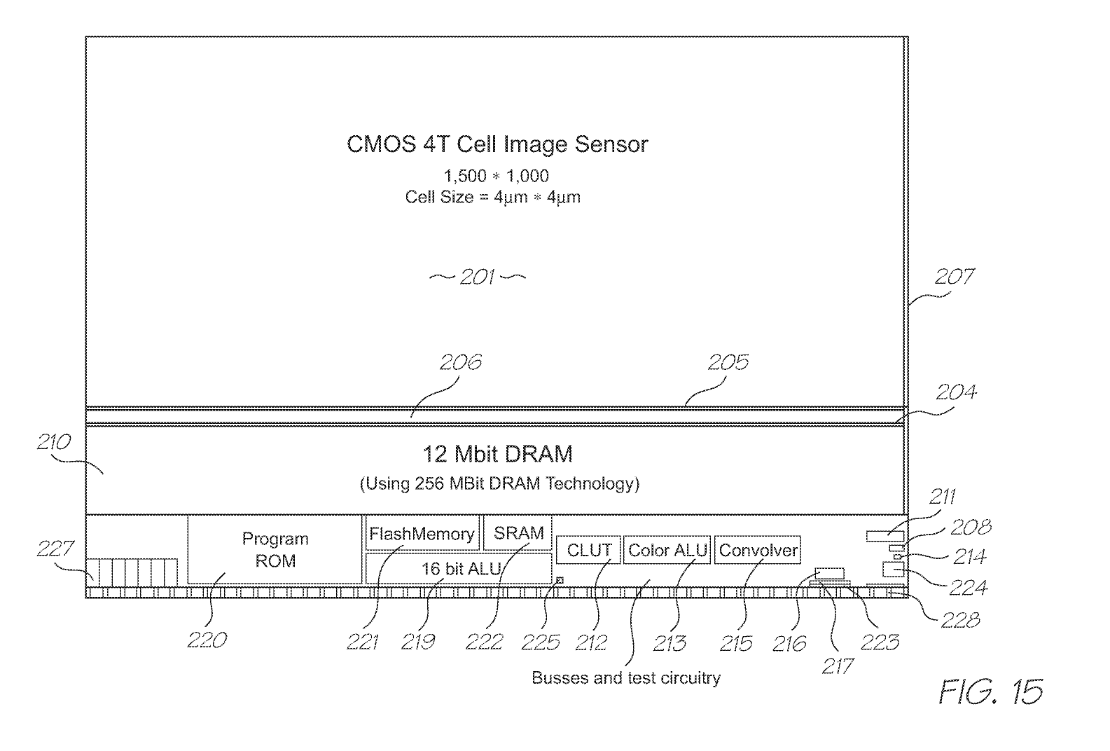

Turning now to FIG. 15, there is shown an example layout of the Image Capture and Processing integrated circuit (ICP) 48.

The Image Capture and Processing integrated circuit 48 provides most of the electronic functionality of the camera with the exception of the print head integrated circuit. The integrated circuit 48 is a highly integrated system. It combines CMOS image sensing, analog to digital conversion, digital image processing, DRAM storage, ROM, and miscellaneous control functions in a single integrated circuit.

The integrated circuit is estimated to be around 32 mm² using a leading edge 0.18 micron CMOS/DRAM/APS process. The integrated circuit size and cost can scale somewhat with Moore's law, but is dominated by a CMOS active pixel sensor array 201, so scaling is limited as the sensor pixels approach the diffraction limit.

The ICP 48 includes CMOS logic, a CMOS image sensor, DRAM, and analog circuitry. A very small amount of flash memory or other non-volatile memory is also preferably included for protection against reverse engineering.

Alternatively, the ICP can readily be divided into two integrated circuits: one for the CMOS imaging array, and the other for the remaining circuitry. The cost of this two integrated circuit solution should not be significantly different than the single integrated circuit ICP, as the extra cost of packaging and bond-pad area is somewhat cancelled by the reduced total wafer area requiring the color filter fabrication steps.

The ICP preferably contains the following functions:

Function

01.5 megapixel image sensor
Analog Signal Processors
Image sensor column decoders
Image sensor row decoders
Analogue to Digital Conversion (ADC)
Column ADC's
Auto exposure
12 Mbits of DRAM
DRAM Address Generator
Color interpolator
Convolver
Color ALU
Halftone matrix ROM
Digital halftoning
Print head interface
8 bit CPU core
Program ROM
Flash memory
Scratchpad SRAM
Parallel interface (8 bit)
Motor drive transistors (5)
Clock PLL
JTAG test interface
Test circuits
Busses
Bond pads

The CPU, DRAM, Image sensor, ROM, Flash memory, Parallel interface, JTAG interface and ADC can be vendor supplied cores. The ICP is intended to run on 1.5V to minimize power consumption and allow convenient operation from two AA type battery cells.

FIG. 15 illustrates a layout of the ICP 48. The ICP 48 is dominated by the imaging array 201, which consumes around 80% of the integrated circuit area. The imaging array is a CMOS 4 transistor active pixel design with a resolution of 1,500×1,000. The array can be divided into the conventional configuration, with two green pixels, one red pixel, and one blue pixel in each pixel group. There are 750×500 pixel groups in the imaging array.

The latest advances in the field of image sensing and CMOS image sensing in particular can be found in the October, 1997 issue of IEEE Transactions on Electron Devices and, in particular, pages 1689 to 1968. Further, a specific implementation similar to that disclosed in the present application is disclosed in Wong et. al, “CMOS Active Pixel Image Sensors Fabricated Using a 1.8V, 0.25 μm CMOS Technology”, IEDM 1996, page 915

The imaging array uses a 4 transistor active pixel design of a standard configuration. To minimize integrated circuit area and therefore cost, the image sensor pixels should be as small as feasible with the technology available. With a four transistor cell, the typical pixel size scales as 20 times the lithographic feature size. This allows a minimum pixel area of around 3.6 μm×3.6 μm. However, the photosite must be substantially above the diffraction limit of the lens. It is also advantageous to have a square photosite, to maximize the margin over the diffraction limit in both horizontal and vertical directions. In this case, the photosite can be specified as 2.5 μm×2.5 μm. The photosite can be a photogate, pinned photodiode, charge modulation device, or other sensor.

The four transistors are packed as an ‘L’ shape, rather than a rectangular region, to allow both the pixel and the photosite to be square. This reduces the transistor packing density slightly, increasing pixel size. However, the advantage in avoiding the diffraction limit is greater than the small decrease in packing density.

The transistors also have a gate length which is longer than the minimum for the process technology. These have been increased from a drawn length of 0.18 micron to a drawn length of 0.36 micron. This is to improve the transistor matching by making the variations in gate length represent a smaller proportion of the total gate length.

The extra gate length, and the ‘L’ shaped packing, mean that the transistors use more area than the minimum for the technology. Normally, around 8 μm² would be required for rectangular packing. Preferably, 9.75 μm² has been allowed for the transistors.

The total area for each pixel is 16 μm², resulting from a pixel size of 4 μm×4 μm. With a resolution of 1,500×1,000, the area of the imaging array 101 is 6,000 μm×4,000 μm, or 24 mm².

The presence of a color image sensor on the integrated circuit affects the process required in two major ways:

The CMOS fabrication process should be optimized to minimize dark current

Color filters are required. These can be fabricated using dyed photosensitive polyimides, resulting in an added process complexity of three spin coatings, three photolithographic steps, three development steps, and three hardbakes.

There are 15,000 analog signal processors (ASPs) 205, one for each of the columns of the sensor. The ASPs amplify the signal, provide a dark current reference, sample and hold the signal, and suppress the fixed pattern noise (FPN).

There are 375 analog to digital converters 206, one for each four columns of the sensor array. These may be delta-sigma or successive approximation type ADC's. A row of low column ADC's are used to reduce the conversion speed required, and the amount of analog signal degradation incurred before the signal is converted to digital. This also eliminates the hot spot (affecting local dark current) and the substrate coupled noise that would occur if a single high speed ADC was used. Each ADC also has two four bit DAC's which trim the offset and scale of the ADC to further reduce FPN variations between columns. These DAC's are controlled by data stored in flash memory during integrated circuit testing.

The column select logic 204 is a 1:1500 decoder which enables the appropriate digital output of the ADCs onto the output bus. As each ADC is shared by four columns, the least significant two bits of the row select control 4 input analog multiplexors.

A row decoder 207 is a 1:1000 decoder which enables the appropriate row of the active pixel sensor array. This selects which of the 1000 rows of the imaging array is connected to analog signal processors. As the rows are always accessed in sequence, the row select logic can be implemented as a shift register.

An auto exposure system 208 adjusts the reference voltage of the ADC 205 in response to the maximum intensity sensed during the previous frame period. Data from the green pixels is passed through a digital peak detector. The peak value of the image frame period before capture (the reference frame) is provided to a digital to analogue converter (DAC), which generates the global reference voltage for the column ADCs. The peak detector is reset at the beginning of the reference frame. The minimum and maximum values of the three RGB color components are also collected for color correction.

The second largest section of the integrated circuit is consumed by a DRAM 210 used to hold the image. To store the 1,500×1,000 image from the sensor without compression, 1.5 Mbytes of DRAM 210 are required. This equals 12 Mbits, or slightly less than 5% of a 256 Mbit DRAM. The DRAM technology assumed is of the 256 Mbit generation implemented using 0.18 μm CMOS.

Using a standard 8F cell, the area taken by the memory array is 3.11 mm². When row decoders, column sensors, redundancy, and other factors are taken into account, the DRAM requires around 4 mm².

This DRAM 210 can be mostly eliminated if analog storage of the image signal can be accurately maintained in the CMOS imaging array for the two seconds required to print the photo. However, digital storage of the image is preferable as it is maintained without degradation, is insensitive to noise, and allows copies of the photo to be printed considerably later.

A DRAM address generator 211 provides the write and read addresses to the DRAM 210. Under normal operation, the write address is determined by the order of the data read from the CMOS image sensor 201. This will typically be a simple raster format. However, the data can be read from the sensor 201 in any order, if matching write addresses to the DRAM are generated. The read order from the DRAM 210 will normally simply match the requirements of a color interpolator and the print head. As the cyan, magenta, and yellow rows of the print head are necessarily offset by a few pixels to allow space for nozzle actuators, the colors are not read from the DRAM simultaneously. However, there is plenty of time to read all of the data from the DRAM many times during the printing process. This capability is used to eliminate the need for FIFOs in the print head interface, thereby saving integrated circuit area. All three RGB image components can be read from the DRAM each time color data is required. This allows a color space converter to provide a more sophisticated conversion than a simple linear RGB to CMY conversion.

Also, to allow two dimensional filtering of the image data without requiring line buffers, data is re-read from the DRAM array.

The address generator may also implement image effects in certain models of camera. For example, passport photos are generated by a manipulation of the read addresses to the DRAM. Also, image framing effects (where the central image is reduced), image warps, and kaleidoscopic effects can all be generated by manipulating the read addresses of the DRAM.

While the address generator 211 may be implemented with substantial complexity if effects are built into the standard integrated circuit, the integrated circuit area required for the address generator is small, as it consists only of address counters and a moderate amount of random logic.

A color interpolator 214 converts the interleaved pattern of red, 2×green, and blue pixels into RGB pixels. It consists of three 8 bit adders and associated registers. The divisions are by either 2 (for green) or 4 (for red and blue) so they can be implemented as fixed shifts in the output connections of the adders.

A convolver 215 is provided as a sharpening filter which applies a small convolution kernel (5×5) to the red, green, and blue planes of the image. The convolution kernel for the green plane is different from that of the red and blue planes, as green has twice as many samples. The sharpening filter has five functions:

To improve the color interpolation from the linear interpolation provided by the color interpolator, to a close approximation of a sinc interpolation.

To compensate for the image ‘softening’ which occurs during digitization.

To adjust the image sharpness to match average consumer preferences, which are typically for the image to be slightly sharper than reality. As the single use camera is intended as a consumer product, and not a professional photographic products, the processing can match the most popular settings, rather than the most accurate.

To suppress the sharpening of high frequency (individual pixel) noise. The function is similar to the ‘unsharp mask’ process.

To antialias Image Warping.

These functions are all combined into a single convolution matrix. As the pixel rate is low (less than 1 Mpixel per second) the total number of multiplies required for the three color channels is 56 million multiplies per second. This can be provided by a single multiplier. Fifty bytes of coefficient ROM are also required.

A color ALU 113 combines the functions of color compensation and color space conversion into the one matrix multiplication, which is applied to every pixel of the frame. As with sharpening, the color correction should match the most popular settings, rather than the most accurate.

A color compensation circuit of the color ALU provides compensation for the lighting of the photo. The vast majority of photographs are substantially improved by a simple color compensation, which independently normalizes the contrast and brightness of the three color components.

A color look-up table (CLUT) 212 is provided for each color component. These are three separate 256×8 SRAMs, requiring a total of 6,144 bits. The CLUTs are used as part of the color correction process. They are also used for color special effects, such as stochastically selected “wild color” effects.

A color space conversion system of the color ALU converts from the RGB color space of the image sensor to the CMY color space of the printer. The simplest conversion is a 1's complement of the RGB data. However, this simple conversion assumes perfect linearity of both color spaces, and perfect dye spectra for both the color filters of the image sensor, and the ink dyes. At the other extreme is a tri-linear interpolation of a sampled three dimensional arbitrary transform table. This can effectively match any non-linearity or differences in either color space. Such a system is usually necessary to obtain good color space conversion when the print engine is a color electrophotographic

However, since the non-linearity of a halftoned ink jet output is very small, a simpler system can be used. A simple matrix multiply can provide excellent results. This requires nine multiplies and six additions per contone pixel. However, since the contone pixel rate is low (less than 1 Mpixel/sec) these operations can share a single multiplier and adder. The multiplier and adder are used in a color ALU which is shared with the color compensation function.

Digital halftoning can be performed as a dispersed dot ordered dither using a stochastic optimized dither cell. A halftone matrix ROM 216 is provided for storing dither cell coefficients. A dither cell size of 32×32 is adequate to ensure that the cell repeat cycle is not visible. The three colors—cyan, magenta, and yellow—are all dithered using the same cell, to ensure maximum co-positioning of the ink dots. This minimizes ‘muddying’ of the mid-tones which results from bleed of dyes from one dot to adjacent dots while still wet. The total ROM size required is 1 KByte, as the one ROM is shared by the halftoning units for each of the three colors.

The digital halftoning used is dispersed dot ordered dither with stochastic optimized dither matrix. While dithering does not produce an image quite as ‘sharp’ as error diffusion, it does produce a more accurate image with fewer artifacts. The image sharpening produced by error diffusion is artificial, and less controllable and accurate than ‘unsharp mask’ filtering performed in the contone domain. The high print resolution (1,600 dpi×1,600 dpi) results in excellent quality when using a well formed stochastic dither matrix.

Digital halftoning is performed by a digital halftoning unit 217 using a simple comparison between the contone information from the DRAM 210 and the contents of the dither matrix 216. During the halftone process, the resolution of the image is changed from the 250 dpi of the captured contone image to the 1,600 dpi of the printed image. Each contone pixel is converted to an average of 40.96 halftone dots.

The ICP incorporates a 16 bit microcontroller CPU core 219 to run the miscellaneous camera functions, such as reading the buttons, controlling the motor and solenoids, setting up the hardware, and authenticating the refill station. The processing power required by the CPU is very modest, and a wide variety of processor cores can be used. As the entire CPU program is run from a small ROM 220[.], program compatibility between camera versions is not important, as no external programs are run. A 2 Mbit (256 Kbyte) program and data ROM 220 is included on integrated circuit. Most of this ROM space is allocated to data for outline graphics and fonts for specialty cameras. The program requirements are minor. The single most complex task is the encrypted authentication of the refill station. The ROM requires a single transistor per bit.

A Flash memory 221 may be used to store a 128 bit authentication code. This provides higher security than storage of the authentication code in ROM, as reverse engineering can be made essentially impossible. The Flash memory is completely covered by third level metal, making the data impossible to extract using scanning probe microscopes or electron beams. The authentication code is stored in the integrated circuit when manufactured. At least two other Flash bits are required for the authentication process: a bit which locks out reprogramming of the authentication code, and a bit which indicates that the camera has been refilled by an authenticated refill station. The flash memory can also be used to store FPN correction data for the imaging array. Additionally, a phase locked loop rescaling parameter is stored for scaling the clocking cycle to an appropriate correct time. The clock frequency does not require crystal accuracy since no date functions are provided. To eliminate the cost of a crystal, an on integrated circuit oscillator with a phase locked loop 224 is used. As the frequency of an on-integrated circuit oscillator is highly variable from integrated circuit to integrated circuit, the frequency ratio of the oscillator to the PLL is digitally trimmed during initial testing. The value is stored in Flash memory 221. This allows the clock PLL to control the ink-jet heater pulse width with sufficient accuracy.

A scratchpad SRAM is a small static RAM 222 with a 6T cell. The scratchpad provided temporary memory for the 16 bit CPU. 1024 bytes is adequate.

A print head interface 223 formats the data correctly for the print head. The print head interface also provides all of the timing signals required by the print head. These timing signals may vary depending upon temperature, the number of dots printed simultaneously, the print medium in the print roll, and the dye density of the ink in the print roll.

The following is a table of external connections to the print head interface:

| Connection | Function | Pins |
|---|---|---|
| DataBits[0-7] | Independent serial data to the eight | 8 |
| | segments of the print head | |
| BitClock | Main data clock for the print head | 1 |
| ColorEnable[0-2] | Independent enable signals for the | 3 |
| | CMY actuators, allowing different | |
| | pulse times for each color. | |
| BankEnable[0-1] | Allows either simultaneous or | 2 |
| | interleaved actuation of two banks | |
| | of nozzles. This allows two different | |
| | print speed/power consumption tradeoffs | |
| NozzleSelect[0-4] | Selects one of 32 banks of nozzles | 5 |
| | for simultaneous actuation | |
| ParallelXferClock | Loads the parallel transfer register | 1 |
| | with the data from the shift registers | |
| Total | | 20 |

The print head utilized is composed of eight identical segments, each 1.25 cm long. There is no connection between the segments on the print head integrated circuit. Any connections required are made in the external TAB bonding film, which is double sided. The division into eight identical segments is to simplify lithography using wafer steppers. The segment width of 1.25 cm fits easily into a stepper field. As the print head integrated circuit is long and narrow (10 cm×0.3 mm), the stepper field contains a single segment of 32 print head integrated circuits. The stepper field is therefore 1.25 cm×1.6 cm. An average of four complete print heads are patterned in each wafer step.

A single BitClock output line connects to all 8 segments on the print head. The 8 DataBits lines lead one to each segment, and are clocked into the 8 segments on the print head simultaneously (on a BitClock pulse). For example, dot 0 is transferred to segment₀, dot 750 is transferred to segment₁, dot 1500 to segment₂ etc simultaneously.

The ParallelXferClock is connected to each of the 8 segments on the print head, so that on a single pulse, all segments transfer their bits at the same time.

The NozzleSelect, BankEnable and ColorEnable lines are connected to each of the 8 segments, allowing the print head interface to independently control the duration of the cyan, magenta, and yellow nozzle energizing pulses. Registers in the Print Head Interface allow the accurate specification of the pulse duration between 0 and 6 ms, with a typical duration of 2 ms to 3 ms.

A parallel interface 125 connects the ICP to individual static electrical signals. The CPU is able to control each of these connections as memory mapped I/O via a low speed bus.

The following is a table of connections to the parallel interface:

| Connection | Direction | Pins |
|---|---|---|
| Paper transport stepper motor | Output | 4 |
| Capping solenoid | Output | 1 |
| Copy LED | Output | 1 |
| Photo button | Input | 1 |
| Copy button | Input | 1 |
| Total | | 8 |

Seven high current drive transistors eg. 227 are required. Four are for the four phases of the main stepper motor, two are for the guillotine motor, and the remaining transistor is to drive the capping solenoid. These transistors are allocated 20,000 square microns (600,000 F) each. As the transistors are driving highly inductive loads, they must either be turned off slowly, or be provided with a high level of back EMF protection. If adequate back EMF protection cannot be provided using the integrated circuit process chosen, then external discrete transistors should be used. The transistors are never driven at the same time as the image sensor is used. This is to avoid voltage fluctuations and hot spots affecting the image quality. Further, the transistors are located as far away from the sensor as possible.

A standard JTAG (Joint Test Action Group) interface 228 is included in the ICP for testing purposes and for interrogation by the refill station. Due to the complexity of the integrated circuit, a variety of testing techniques are required, including BIST (Built In Self Test) and functional block isolation. An overhead of 10% in integrated circuit area is assumed for integrated circuit testing circuitry for the random logic portions. The overhead for the large arrays the image sensor and the DRAM is smaller.

The JTAG interface is also used for authentication of the refill station. This is included to ensure that the cameras are only refilled with quality paper and ink at a properly constructed refill station, thus preventing inferior quality refills from occurring. The camera must authenticate the refill station, rather than vice versa. The secure protocol is communicated to the refill station during the automated test procedure. Contact is made to four gold plated spots on the ICP/print head TAB by the refill station as the new ink is injected into the print head.

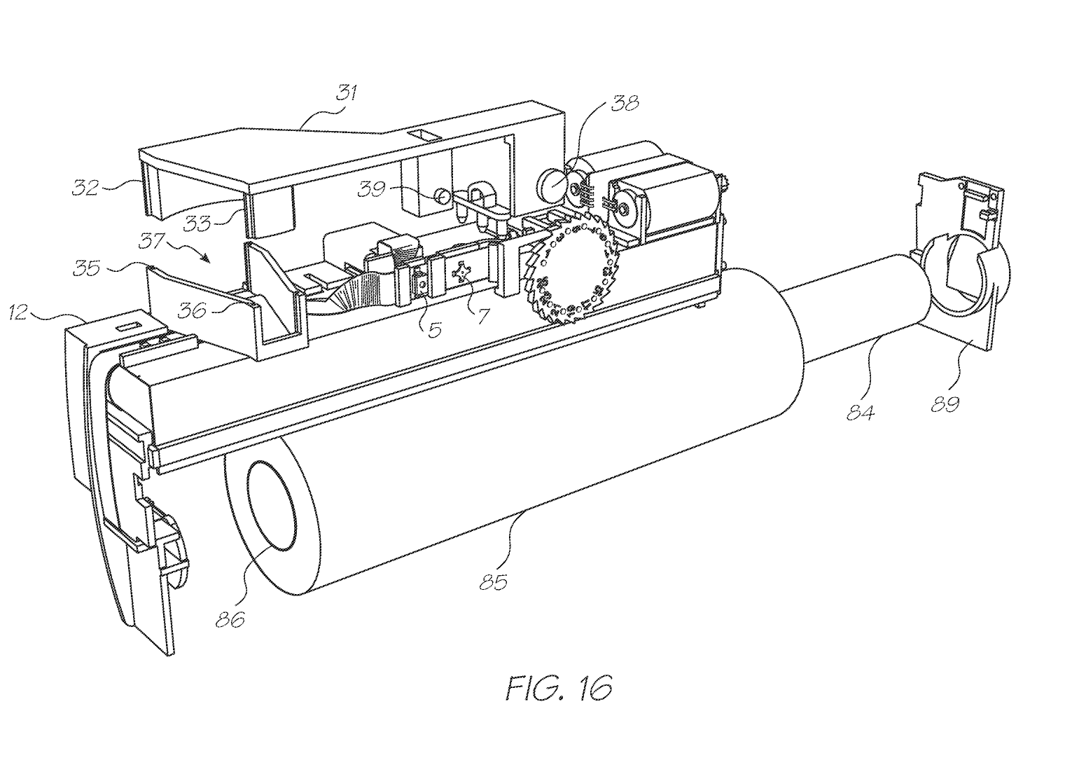

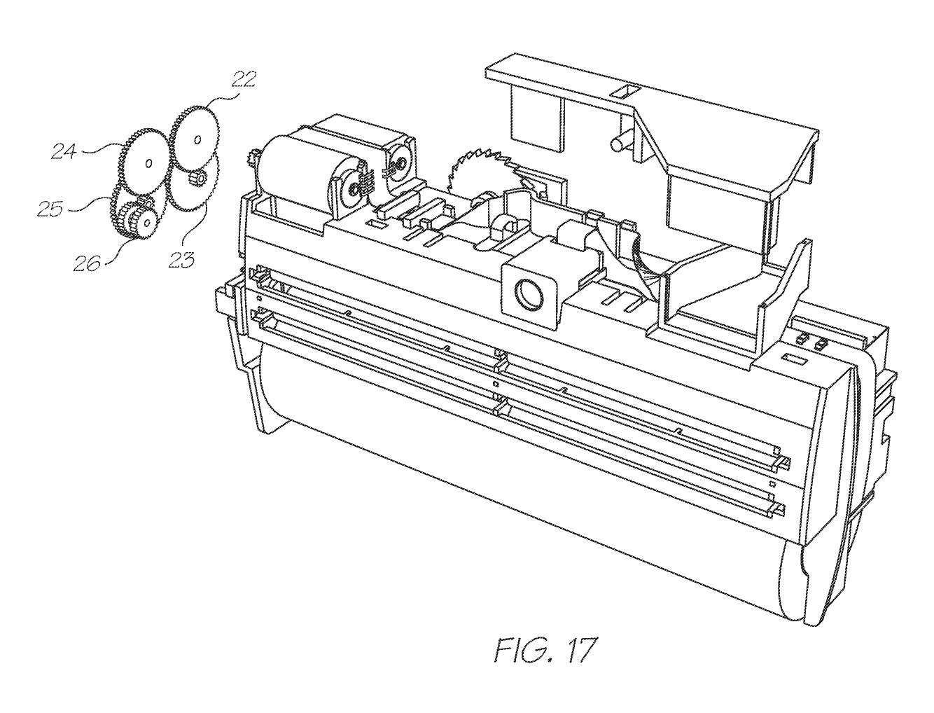

FIG. 16 illustrates a rear view of the next step in the construction process whilst FIG. 17 illustrates a front view.

Turning now to FIG. 16, the assembly of the camera system proceeds via first assembling the ink supply mechanism 40. The flex PCB is interconnected with batteries 84 only one of which is shown, which are inserted in the middle portion of a print roll 85 which is wrapped around a plastic former 86. An end cap 89 is provided at the other end of the print roll 85 so as to fasten the print roll and batteries firmly to the ink supply mechanism.

The solenoid coil is interconnected (not shown) to interconnects 97, 98 (FIG. 8) which include leaf spring ends for interconnection with electrical contacts on the Flex PCB so as to provide for electrical control of the solenoid.

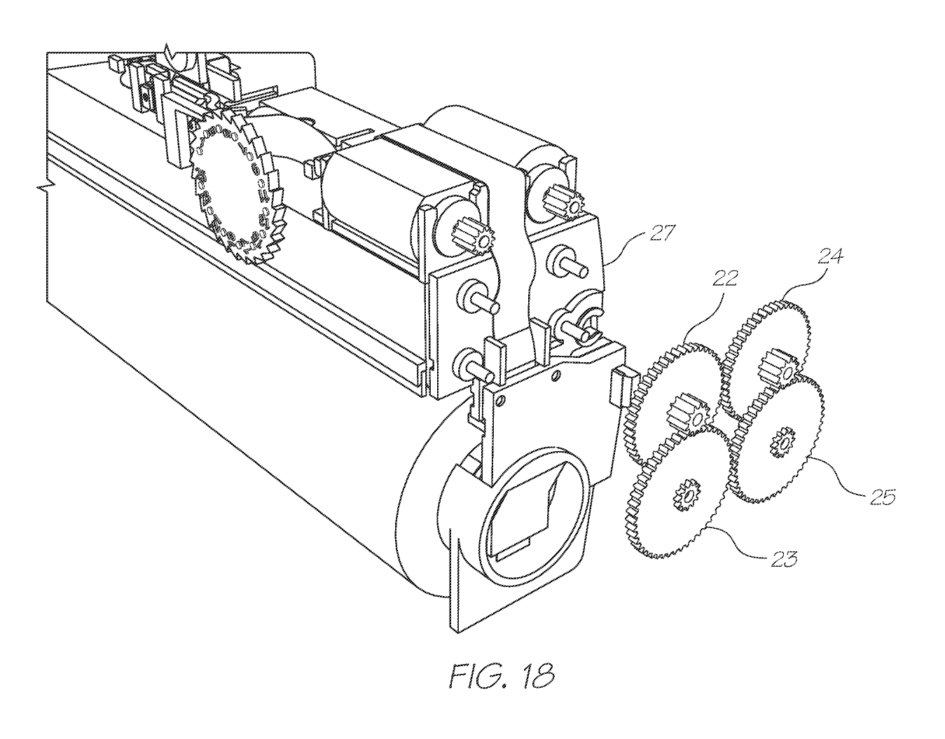

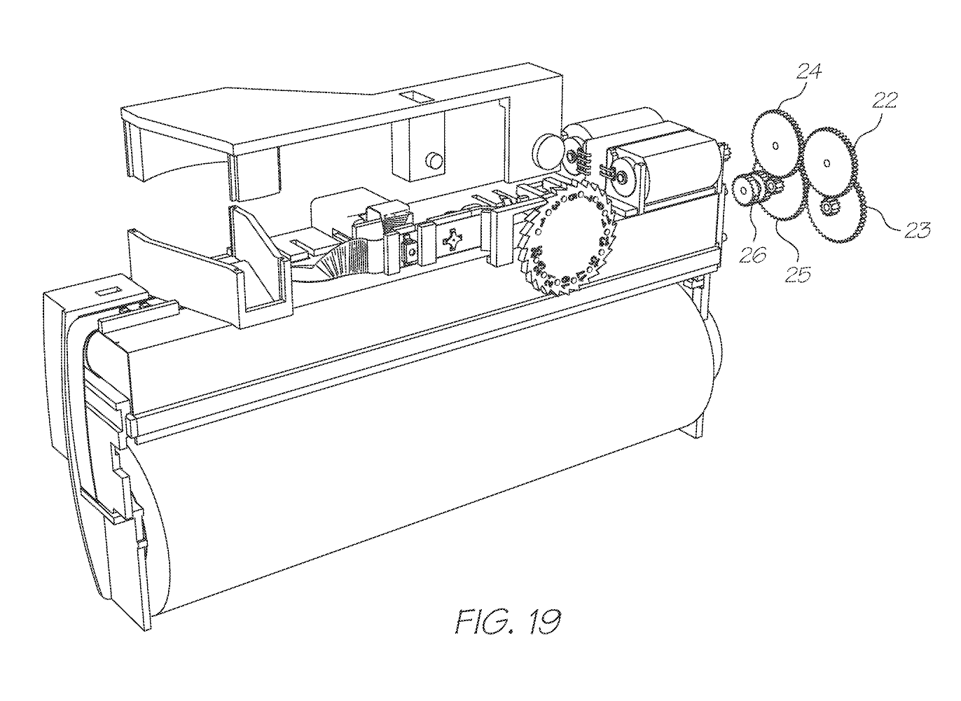

Turning now to FIGS. 17-19 the next step in the construction process is the insertion of the relevant gear trains into the side of the camera chassis. FIG. 17 illustrates a front view, FIG. 18 illustrates a rear view and FIG. 19 also illustrates a rear view. The first gear train comprising gear wheels 22, 23 is utilised for driving the guillotine blade with the gear wheel 23 engaging the gear wheel 65 of FIG. 8. The second gear train comprising gear wheels 24, 25 and 26 engage one end of the print roller 61 of FIG. 8. As best indicated in FIG. 18, the gear wheels mate with corresponding pins on the surface of the chassis with the gear wheel 26 being snap fitted into corresponding mating hole 27.

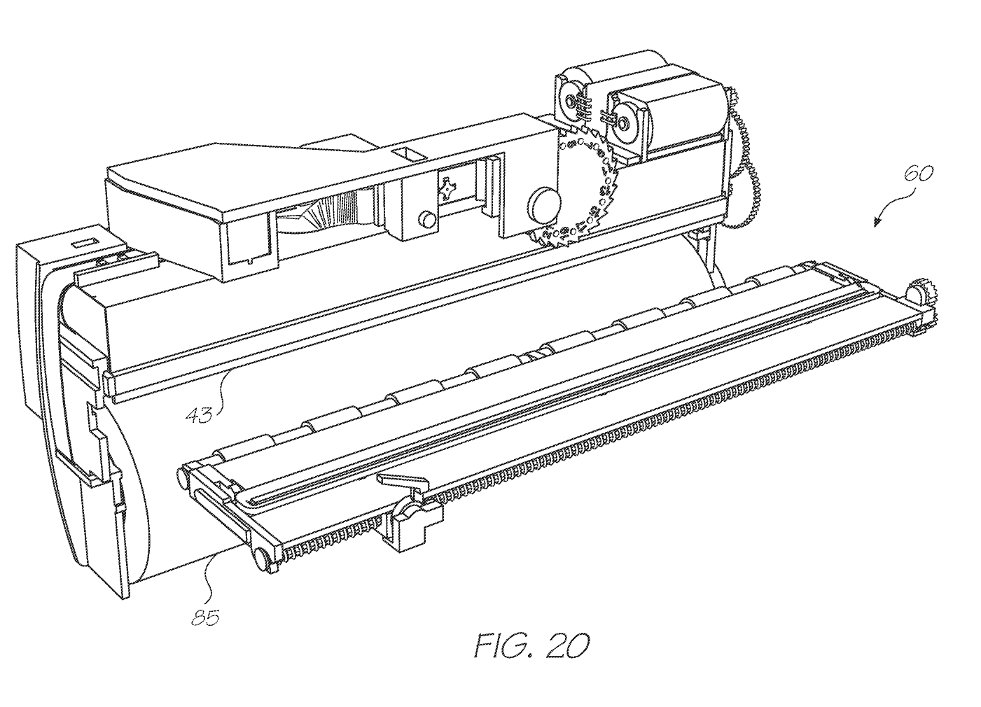

Next, as illustrated in FIG. 20, the assembled platen unit 60 is then inserted between the print roll 85 and aluminium cutting blade 43.

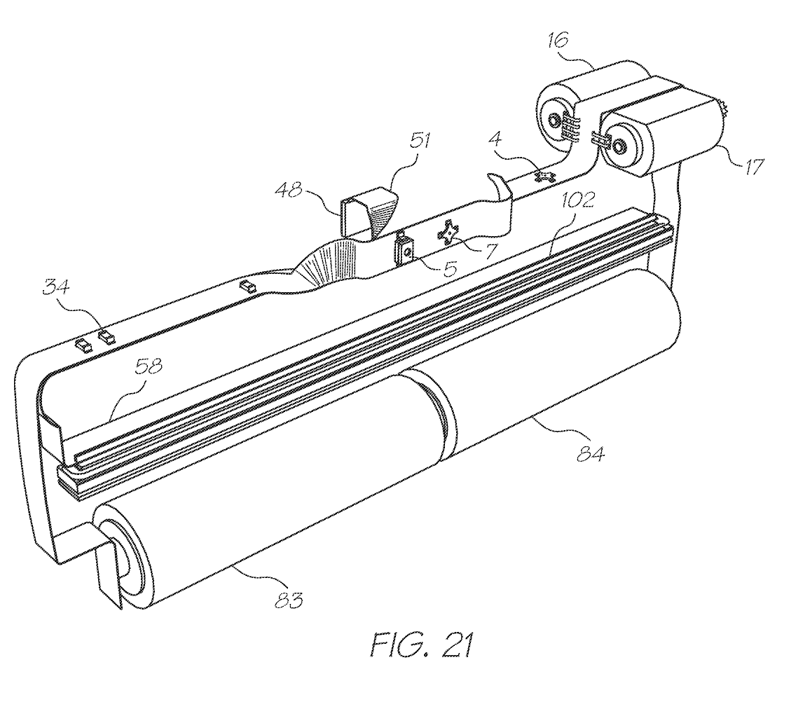

Turning now to FIG. 21, by way of illumination, there is illustrated the electrically interactive components of the camera system. As noted previously, the components are based around a Flex PCB board and include a TAB film 58 which interconnects the printhead 102 with the image sensor and processing integrated circuit 48. Power is supplied by two AA type batteries 83, 84 and a paper drive stepper motor 16 is provided in addition to a rotary guillotine motor 17.

An optical element 31 is provided for snapping into a top portion of the chassis 12. The optical element 31 includes portions defining an optical view finder 32, 33 which are slotted into mating portions 35, 36 in view finder channel 37. Also provided in the optical element 31 is a lensing system 38 for magnification of the prints left number in addition to an optical pipe element 39 for piping light from the LED 5 for external display.

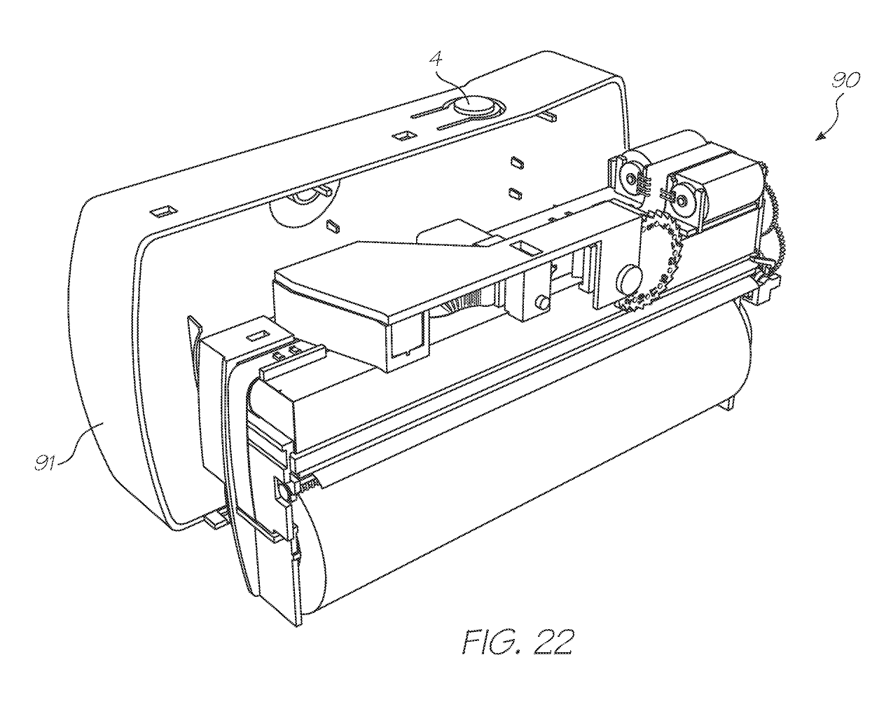

Turning next to FIG. 22, the assembled unit 90 is then inserted into a front outer case 91 which includes button 4 for activation of printouts.

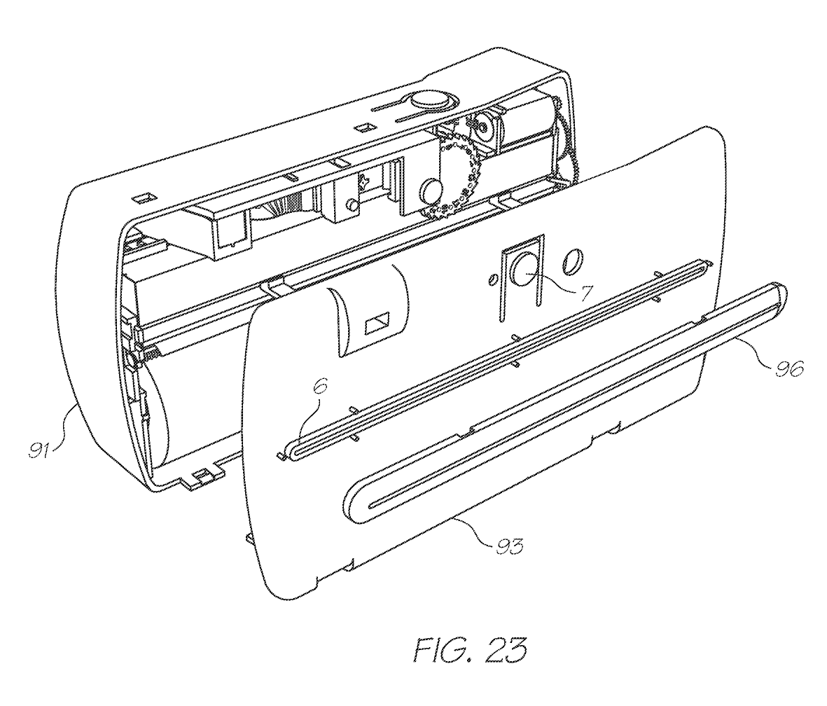

Turning now to FIG. 23, next, the unit 90 is provided with a snap-on back cover 93 which includes a slot 6 and copy print button 7. A wrapper label containing instructions and advertising (not shown) is then wrapped around the outer surface of the camera system and pinch clamped to the cover by means of clamp strip 96 which can comprise a flexible plastic or rubber strip.

Subsequently, the preferred embodiment is ready for use as a one time use camera system that provides for instant output images on demand. It will be evident that the preferred embodiment further provides for a refillable camera system. A used camera can be collected and its outer plastic cases removed and recycled. A new paper roll and batteries can be added and the ink cartridge refilled. A series of automatic test routines can then be carried out to ensure that the printer is properly operational. Further, in order to ensure only authorised refills are conducted so as to enhance quality, routines in the on-integrated circuit program ROM can be executed such that the camera authenticates the refilling station using a secure protocol. Upon authentication, the camera can reset an internal paper count and an external case can be fitted on the camera system with a new outer label. Subsequent packing and shipping can then take place.

It will be further readily evident to those skilled in the art that the program ROM can be modified so as to allow for a variety of digital processing routines. In addition to the digitally enhanced photographs optimised for mainstream consumer preferences, various other models can readily be provided through mere re-programming of the program ROM. For example, a sepia classic old fashion style output can be provided through a remapping of the colour mapping function. A further alternative is to provide for black and white outputs again through a suitable colour remapping algorithm. Minimum colour can also be provided to add a touch of colour to black and white prints to produce the effect that was traditionally used to colourize black and white photos. Further, passport photo output can be provided through suitable address remappings within the address generators. Further, edge filters can be utilised as is known in the field of image processing to produce sketched art styles. Further, classic wedding borders and designs can be placed around an output image in addition to the provision of relevant clip arts. For example, a wedding style camera might be provided. Further, a panoramic mode can be provided so as to output the well known panoramic format of images. Further, a postcard style output can be provided through the printing of postcards including postage on the back of a print roll surface. Further, cliparts can be provided for special events such as Halloween, Christmas etc. Further, kaleidoscopic effects can be provided through address remappings and wild colour effects can be provided through remapping of the colour lookup table. Many other forms of special event cameras can be provided for example, cameras dedicated to the Olympics, movie tie-ins, advertising and other special events.

The operational mode of the camera can be programmed so that upon the depressing of the take photo a first image is sampled by the sensor array to determine irrelevant parameters. Next a second image is again captured which is utilised for the output. The captured image is then manipulated in accordance with any special requirements before being initially output on the paper roll. The LED light is then activated for a predetermined time during which the DRAM is refreshed so as to retain the image. If the print copy button is depressed during this predetermined time interval, a further copy of the photo is output. After the predetermined time interval where no use of the camera has occurred, the onboard CPU shuts down all power to the camera system until such time as the take button is again activated. In this way, substantial power savings can be realized.

### Ink Jet Technologies

The embodiments of the invention use an ink jet printer type device. Of course many different devices could be used. However presently popular ink jet printing technologies are unlikely to be suitable.

The most significant problem with thermal inkjet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal inkjet applications. This leads to an efficiency of around 0.02%, from electricity input to drop momentum (and increased surface area) out.

The most significant problem with piezoelectric inkjet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per print head, but is a major impediment to the fabrication of pagewide print heads with 19,200 nozzles.

Ideally, the inkjet technologies used meet the stringent requirements of in-camera digital color printing and other high quality, high speed, low cost printing applications. To meet the requirements of digital photography, new inkjet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the inkjet systems described below with differing levels of difficulty. 45 different inkjet technologies have been developed by the Assignee to give a wide range of choices for high volume manufacture. These technologies form part of separate applications assigned to the present Assignee as set out in the table below.

The inkjet designs shown here are suitable for a wide range of digital printing systems, from battery powered one-time use digital cameras, through to desktop and network printers, and through to commercial printing systems

For ease of manufacture using standard process equipment, the print head is designed to be a monolithic 0.5 micron CMOS integrated circuit with MEMS post processing. For color photographic applications, the print head is 100 mm long, with a width which depends upon the inkjet type. The smallest print head designed is IJ38, which is 0.35 mm wide, giving a integrated circuit area of 35 square mm. The print heads each contain 19,200 nozzles plus data and control circuitry.

Ink is supplied to the back of the print head by injection molded plastic ink channels. The molding requires 50 micron features, which can be created using a lithographically micromachined insert in a standard injection molding tool Ink flows through holes etched through the wafer to the nozzle chambers fabricated on the front surface of the wafer. The print head is connected to the camera circuitry by tape automated bonding.

### Cross-Referenced Applications

The following table is a guide to cross-referenced patent applications filed concurrently herewith and discussed hereinafter with the reference being utilized in subsequent tables when referring to a particular case:

| Docket | | |
|---|---|---|
| No. | Off. No | Title |
| IJ01US | 6227652 | Radiant Plunger Ink Jet Printer |
| IJ02US | 6213588 | Electrostatic Ink Jet Printer |
| IJ03US | 6213589 | Planar Thermoelastic Bend Actuator Ink Jet |
| IJ04US | 6231163 | Stacked Electrostatic Ink Jet Printer |
| IJ05US | 6247795 | Reverse Spring Lever Ink Jet Printer |
| IJ06US | 6394581 | Paddle Type Ink Jet Printer |
| IJ07US | 6244691 | Permanent Magnet Electromagnetic Ink |
| | | Jet Printer |
| IJ08US | 6257704 | Planar Swing Grill Electromagnetic Ink |
| | | Jet Printer |
| IJ09US | 6416168 | Pump Action Refill Ink Jet Printer |
| IJ10US | 6220694 | Pulsed Magnetic Field Ink Jet Printer |
| IJ11US | 6257705 | Two Plate Reverse Firing Electromagnetic |
| | | Ink Jet Printer |
| IJ12US | 6247794 | Linear Stepper Actuator Ink Jet Printer |
| IJ13US | 6234610 | Gear Driven Shutter Ink Jet Printer |
| IJ14US | 6247793 | Tapered Magnetic Pole Electromagnetic Ink |
| | | Jet Printer |
| IJ15US | 6264306 | Linear Spring Electromagnetic Grill Ink |
| | | Jet Printer |
| IJ16US | 6241342 | Lorenz Diaphragm Electromagnetic Ink |
| | | Jet Printer |
| IJ17US | 6247792 | PTFE Surface Shooting Shuttered Oscillating |
| | | Pressure Ink Jet Printer |
| IJ18US | 6264307 | Buckle Grip Oscillating Pressure Ink |
| | | Jet Printer |
| IJ19US | 6254220 | Shutter Based Ink Jet Printer |
| IJ20US | 6234611 | Curling Calyx Thermoelastic Ink Jet Printer |
| IJ21US | 6302528 | Thermal Actuated Ink Jet Printer |
| IJ22US | 6283582 | Iris Motion Ink Jet Printer |
| IJ23US | 6239821 | Direct Firing Thermal Bend Actuator Ink |
| | | Jet Printer |
| IJ24US | 6338547 | Conductive PTFE Ben Activator Vented Ink |
| | | Jet Printer |
| IJ25US | 6247796 | Magnetostrictive Ink Jet Printer |
| IJ26US | 6557977 | Shape Memory Alloy Ink Jet Printer |
| IJ27US | 6390603 | Buckle Plate Ink Jet Printer |
| IJ28US | 6362843 | Thermal Elastic Rotary Impeller Ink Jet Printer |
| IJ29US | 6293653 | Thermoelastic Bend Actuator Ink Jet Printer |
| IJ30US | 6312107 | Thermoelastic Bend Actuator Using PTFE |
| | | and Corrugated Copper Ink Jet Printer |
| IJ31US | 6227653 | Bend Actuator Direct Ink Supply Ink |
| | | Jet Printer |
| IJ32US | 6234609 | A High Young's Modulus Thermoelastic Ink |
| | | Jet Printer |
| IJ33US | 6238040 | Thermally actuated slotted chamber wall ink |
| | | jet printer |
| IJ34US | 6188415 | Ink Jet Printer having a thermal actuator |
| | | comprising an external coiled spring |
| IJ35US | 6227654 | Trough Container Ink Jet Printer |
| IJ36US | 6209989 | Dual Chamber Single Vertical Actuator Ink Jet |
| IJ37US | 6247791 | Dual Nozzle Single Horizontal Fulcrum |
| | | Actuator Ink Jet |
| IJ38US | 6336710 | Dual Nozzle Single Horizontal Actuator Ink Jet |
| IJ39US | 6217153 | A single bend actuator cupped paddle ink |
| | | jet printing device |
| IJ40US | 6416167 | A thermally actuated ink jet printer having |
| | | a series of thermal actuator units |
| IJ41US | 6243113 | A thermally actuated ink jet printer |
| | | including a tapered heater element |
| IJ42US | 6283581 | Radial Back-Curling Thermoelastic Ink Jet |
| IJ43US | 6247790 | Inverted Radial Back-Curling Thermoelastic |
| | | Ink Jet |
| IJ44US | 6260953 | Surface bend actuator vented ink supply ink |
| | | jet printer |
| IJ45US | 6267469 | Coil Acutuated Magnetic Plate Ink Jet Printer |

### Tables of Drop-on-Demand Inkjets

Eleven important characteristics of the fundamental operation of individual inkjet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of inkjet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of inkjet nozzle. While not all of the possible combinations result in a viable inkjet technology, many million configurations are viable. It is clearly impractical to elucidate all of the possible configurations. Instead, certain inkjet types have been investigated in detail. These are designated IJ01 to IJ45 above.

Other inkjet configurations can readily be derived from these 45 examples by substituting alternative configurations along one or more of the 11 axes. Most of the IJ01 to IJ45 examples can be made into inkjet print heads with characteristics superior to any currently available inkjet technology.

Where there are prior art examples known to the inventor, one or more of these examples are listed in the examples column of the tables below. The IJ01 to IJ45 series are also listed in the examples column. In some cases, a printer may be listed more than once in a table, where it shares characteristics with more than one entry.

Suitable applications include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

### Actuator Mechanism (Applied Only to Selected Ink Drops)

| Actuator | | | | |
|---|---|---|---|---|
| Mechanism | Description | Advantages | Disadvantages | Examples |
| Thermal | An electrothermal heater heats the | 1) Large force generated | 6) High power | 16) Canon |
| bubble | ink to above boiling point, | 2) Simple construction | 7) Ink carrier limited to water | Bubblejet 1979 |
| | transferring significant heat to the | 3) No moving parts | 8) Low efficiency | Endo et al GB |
| | aqueous ink. A bubble nucleates | 4) Fast operation | 9) High temperatures required | patent 2,007,162 |
| | and quickly forms, expelling the | 5) Small integrated circuit | 10) High mechanical stress | 17) Xerox heater- |
| | ink. | area required for actuator | 11) Unusual materials required | in-pit 1990 |
| | The efficiency of the process is | | 12) Large drive transistors | Hawkins et al U.S. Pat. No. |
| | low, with typically less than | | 13) Cavitation causes actuator | 4,899,181 |
| | 0.05% of the electrical energy | | failure | 18) Hewlett- |
| | being transformed into kinetic | | 14) Kogation reduces bubble | Packard TIJ 1982 |
| | energy of the drop. | | formation | Vaught et al U.S. Pat. No. |
| | | | 15) Large print heads are difficult | 4,490,728 |
| | | | to fabricate | |
| Piezoelectric | A piezoelectric crystal such as | 19) Low power | 23) Very large area required for | 28) Kyser et al |
| | lead lanthanum zirconate (PZT) is | consumption | actuator | U.S. Pat. No. 3,946,398 |
| | electrically activated, and either | 20) Many ink types can | 24) Difficult to integrate with | 29) Zoltan U.S. Pat. No. |
| | expands, shears, or bends to apply | be used | electronics | 3,683,212 |
| | pressure to the ink, ejecting drops. | 21) Fast operation | 25) High voltage drive transistors | 30) 1973 Stemme |
| | | 22) High efficiency | required | U.S. Pat. No. 3,747,120 |
| | | | 26) Full pagewidth print heads | 31) Epson Stylus |
| | | | impractical due to actuator size | 32) Tektronix |
| | | | 27) Requires electrical poling in | 33) IJ04 |
| | | | high field strengths during | |
| | | | manufacture | |
| Electro- | An electric field is used to | 34) Low power | 39) Low maximum strain (approx. | 44) Seiko Epson, |
| strictive | activate electrostriction in relaxor | consumption | 0.01%) | Usui et all JP |
| | materials such as lead lanthanum | 35) Many ink types can | 40) Large area required for | 253401/96 |
| | zirconate titanate (PLZT) or lead | be used | actuator due to low strain | 45) IJ04 |
| | magnesium niobate (PMN). | 36) Low thermal | 41) Response speed is marginal (~ | |
| | | expansion | 10 μs) | |
| | | 37) Electric field | 42) High voltage drive transistors | |
| | | strength required (approx. | required | |
| | | 3.5 V/μm) can be | 43) Full pagewidth print heads | |
| | | generated without | impractical due to actuator size | |
| | | difficulty | | |
| | | 38) Does not require | | |
| | | electrical poling | | |
| Ferroelectric | An electric field is used to induce | 46) Low power | 52) Difficult to integrate with | 55) IJ04 |
| | a phase transition between the | consumption | electronics | |
| | antiferroelectric (AFE) and | 47) Many ink types can | 53) Unusual materials such as | |
| | ferroelectric (FE) phase. | be used | PLZSnT are required | |
| | Perovskite materials such as tin | 48) Fast operation (<1 μs) | 54) Actuators require a large area | |
| | modified lead lanthanum | 49) Relatively high | | |
| | zirconate titanate (PLZSnT) | longitudinal strain | | |
| | exhibit large strains of up to 1% | 50) High efficiency | | |
| | associated with the AFE to FE | 51) Electric field | | |
| | phase transition. | strength of around 3 V/μm | | |
| | | can be readily | | |
| | | provided | | |
| Electrostatic | Conductive plates are separated | 56) Low power | 59) Difficult to operate | 64) IJ02, IJ04 |
| plates | by a compressible or fluid | consumption | electrostatic devices in an aqueous | |
| | dielectric (usually air). Upon | 57) Many ink types can | environment | |
| | application of a voltage, the plates | be used | 60) The electrostatic actuator will | |
| | attract each other and displace | 58) Fast operation | normally need to be separated from | |
| | ink, causing drop ejection. The | | the ink | |
| | conductive plates may be in a | | 61) Very large area required to | |
| | comb or honeycomb structure, or | | achieve high forces | |
| | stacked to increase the surface | | 62) High voltage drive transistors | |
| | area and therefore the force. | | may be required | |
| | | | 63) Full pagewidth print heads are | |
| | | | not competitive due to actuator size | |
| Electrostatic | A strong electric field is applied | 65) Low current | 67) High voltage required | 72) 1989 Saito et |
| pull on ink | to the ink, whereupon electrostatic | consumption | 68) May be damaged by sparks due | al, U.S. Pat. No. 4,799,068 |
| | attraction accelerates the ink | 66) Low temperature | to air breakdown | 73) 1989 Miura et |
| | towards the print medium. | | 69) Required field strength | al, U.S. Pat. No. 4,810,954 |
| | | | increases as the drop size decreases | 74) Tone-jet |
| | | | 70) High voltage drive transistors | |
| | | | required | |
| | | | 71) Electrostatic field attracts dust | |
| Permanent | An electromagnet directly attracts | 75) Low power | 80) Complex fabrication | 86) IJ07, IJ10 |
| magnet electro- | a permanent magnet, displacing | consumption | 81) Permanent magnetic material | |
| magnetic | ink and causing drop ejection. | 76) Many ink types can | such as Neodymium Iron Boron | |
| | Rare earth magnets with a field | be used | (NdFeB) required. | |
| | strength around 1 Tesla can be | 77) Fast operation | 82) High local currents required | |
| | used. Examples are: Samarium | 78) High efficiency | 83) Copper metalization should be | |
| | Cobalt (SaCo) and magnetic | 79) Easy extension from | used for long electromigration | |
| | materials in the neodymium iron | single nozzles to | lifetime and low resistivity | |
| | boron family (NdFeB, | pagewidth print heads | 84) Pigmented inks are usually | |
| | NdDyFeBNb, NdDyFeB, etc) | | infeasible | |
| | | | 85) Operating temperature limited | |
| | | | to the Curie temperature (around | |
| | | | 540 K) | |
| Soft magnetic | A solenoid induced a magnetic | 87) Low power | 92) Complex fabrication | 98) IJ01, IJ05, |
| core electro- | field in a soft magnetic core or | consumption | 93) Materials not usually present in | IJ08, IJ10 |
| magnetic | yoke fabricated from a ferrous | 88) Many ink types can | a CMOS fab such as NiFe, CoNiFe, | 99) IJ12, IJ14, |
| | material such as electroplated iron | be used | or CoFe are required | IJ15, IJ17 |
| | alloys such as CoNiFe [1], CoFe, | 89) Fast operation | 94) High local currents required | |
| | or NiFe alloys. Typically, the soft | 90) High efficiency | 95) Copper metalization should be | |
| | magnetic material is in two parts, | 91) Easy extension from | used for long electromigration | |
| | which are normally held apart by | single nozzles to | lifetime and low resistivity | |
| | a spring. When the solenoid is | pagewidth print heads | 96) Electroplating is required | |
| | actuated, the two parts attract, | | 97) High saturation flux density is | |
| | displacing the ink. | | required (2.0-2.1 T is achievable | |
| | | | with CoNiFe [1]) | |
| Magnetic | The Lorenz force acting on a | 100) Low power | 105) Force acts as a twisting motion | 110) IJ06, IJ11, |
| Lorenz force | current carrying wire in a | consumption | 106) Typically, only a quarter of the | IJ13, IJ16 |
| | magnetic field is utilized. | 101) Many ink types can | solenoid length provides force in a | |
| | This allows the magnetic field to | be used | useful direction | |
| | be supplied externally to the print | 102) Fast operation | 107) High local currents required | |
| | head, for example with rare earth | 103) High efficiency | 108) Copper metalization should be | |
| | permanent magnets. | 104) Easy extension from | used for long electromigration | |
| | Only the current carrying wire | single nozzles to | lifetime and low resistivity | |
| | need be fabricated on the print- | pagewidth print heads | 109) Pigmented inks are usually | |
| | head, simplifying materials | | infeasible | |
| | requirements. | | | |
| Magneto- | The actuator uses the giant | 111) Many ink types can | 115) Force acts as a twisting motion | 120) Fischenbeck, |
| striction | magnetostrictive effect of | be used | 116) Unusual materials such as | U.S. Pat. No. 4,032,929 |
| | materials such as Terfenol-D (an | 112) Fast operation | Terfenol-D are required | 121) IJ25 |
| | alloy of terbium, dysprosium and | 113) Easy extension from | 117) High local currents required | |
| | iron developed at the Naval | single nozzles to | 118) Copper metalization should be | |
| | Ordnance Laboratory, hence Ter- | pagewidth print heads | used for long electromigration | |
| | Fe-NOL). For best efficiency, the | 114) High force is | lifetime and low resistivity | |
| | actuator should be pre-stressed to | available | 119) Pre-stressing may be required | |
| | approx. 8 MPa. | | | |
| Surface tension | Ink under positive pressure is held | 122) Low power | 127) Requires supplementary force | 130) Silverbrook, |
| reduction | in a nozzle by surface tension. | consumption | to effect drop separation | EP 0771 658 A2 |
| | The surface tension of the ink is | 123) Simple construction | 128) Requires special ink | and related patent |
| | reduced below the bubble | 124) No unusual materials | surfactants | applications |
| | threshold, causing the ink to | required in fabrication | 129) Speed may be limited by | |
| | egress from the nozzle. | 125) High efficiency | surfactant properties | |
| | | 126) Easy extension from | | |
| | | single nozzles to | | |
| | | pagewidth print heads | | |
| Viscosity | The ink viscosity is locally | 131) Simple construction | 134) Requires supplementary force | 139) Silverbrook, |
| reduction | reduced to select which drops are | 132) No unusual materials | to effect drop separation | EP 0771 658 A2 |
| | to be ejected. A viscosity | required in fabrication | 135) Requires special ink viscosity | and related patent |
| | reduction can be achieved | 133) Easy extension from | properties | applications |
| | electrothermally with most inks, | single nozzles to | 136) High speed is difficult to | |
| | but special inks can be engineered | pagewidth print heads | achieve | |
| | for a 100:1 viscosity reduction. | | 137) Requires oscillating ink | |
| | | | pressure | |
| | | | 138) A high temperature difference | |
| | | | (typically 80 degrees) is required | |
| Acoustic | An acoustic wave is generated and | 140) Can operate without | 141) Complex drive circuitry | 146) 1993 |
| | focussed upon the drop ejection | a nozzle plate | 142) Complex fabrication | Hadimioglu et al, |
| | region. | | 143) Low efficiency | EUP 550,192 |
| | | | 144) Poor control of drop position | 147) 1993 Elrod et |
| | | | 145) Poor control of drop volume | al, EUP 572,220 |
| Thermoelastic | An actuator which relies upon | 148) Low power | 157) Efficient aqueous operation | 160) IJ03, IJ09, |
| bend actuator | differential thermal expansion | consumption | requires a thermal insulator on the | IJ17, IJ18 |
| | upon Joule heating is used. | 149) Many ink types can | hot side | 161) IJ19, IJ20, |
| | | be used | 158) Corrosion prevention can be | IJ21, IJ22 |
| | | 150) Simple planar | difficult | 162) IJ23, IJ24, |
| | | fabrication | 159) Pigmented inks may be | IJ27, IJ28 |
| | | 151) Small integrated | infeasible, as pigment particles may | 163) IJ29, IJ30, |
| | | circuit area required for | jam the bend actuator | IJ31, IJ32 |
| | | each actuator | | 164) IJ33, IJ34, |
| | | 152) Fast operation | | IJ35, IJ36 |
| | | 153) High efficiency | | 165) IJ37, IJ38, |
| | | 154) CMOS compatible | | IJ39, IJ40 |
| | | voltages and currents | | 166) IJ41 |
| | | 155) Standard MEMS | | |
| | | processes can be used | | |
| | | 156) Easy extension from | | |
| | | single nozzles to | | |
| | | pagewidth printheads | | |
| High CTE | A material with a very high | 167) High force can be | 177) Requires special material (e.g. | 181) IJ09, IJ17, |
| thermoelastic | coefficient of thermal expansion | generated | PTFE) | IJ18, IJ20 |
| actuator | (CTE) such as | 168) PTFE is a candidate | 178) Requires a PTFE deposition | 182) IJ21, IJ22, |
| | polytetrafluoroethylene (PTFE) is | for low dielectric constant | process, which is not yet standard in | IJ23, IJ24 |
| | used. As high CTE materials are | insulation in ULSI | ULSI fabs | 183) IJ27, IJ28, |
| | usually non-conductive, a heater | 169) Very low power | 179) PTFE deposition cannot be | IJ29, IJ30 |
| | fabricated from a conductive | consumption | followed with high temperature | 184) IJ31, IJ42, |
| | material is incorporated. A 50 μm | 170) Many ink types can | (above 350° C.) processing | IJ43, IJ44 |
| | long PTFE bend actuator with | be used | 180) Pigmented inks may be | |
| | polysilicon heater and 15 mW | 171) Simple planar | infeasible, as pigment particles may | |
| | power input can provide 180 μN | fabrication | jam the bend actuator | |
| | force and 10 μm deflection. | 172) Small integrated | | |
| | Actuator motions include: | circuit area required for | | |
| | Bend | each actuator | | |
| | Push | 173) Fast operation | | |
| | Buckle | 174) High efficiency | | |
| | Rotate | 175) CMOS compatible | | |
| | | voltages and currents | | |
| | | 176) Easy extension from | | |
| | | single nozzles to | | |
| | | pagewidth print heads | | |
| Conductive | A polymer with a high coefficient | 185) High force can be | 194) Requires special materials | 199) IJ24 |
| polymer | of thermal expansion (such as | generated | development (High CTE conductive | |
| thermoelastic | PTFE) is doped with conducting | 186) Very low power | polymer) | |
| actuator | substances to increase its | consumption | 195) Requires a PTFE deposition | |
| | conductivity to about 3 orders of | 187) Many ink types can | process, which is not yet standard in | |
| | magnitude below that of copper. | be used | ULSI fabs | |
| | The conducting polymer expands | 188) Simple planar | 196) PTFE deposition cannot be | |
| | when resistively heated. | fabrication | followed with high temperature | |
| | Examples of conducting dopants | 189) Small integrated | (above 350° C.) processing | |
| | include: | circuit area required for | 197) Evaporation and CVD | |
| | Carbon nanotubes | each actuator | deposition techniques cannot be | |
| | Metal fibers | 190) Fast operation | used | |
| | Conductive polymers such as | 191) High efficiency | 198) Pigmented inks may be | |
| | doped polythiophene | 192) CMOS compatible | infeasible, as pigment particles may | |
| | Carbon granules | voltages and currents | jam the bend actuator | |
| | | 193) Easy extension from | | |
| | | single nozzles to | | |
| | | pagewidth print heads | | |
| Shape memory | A shape memory alloy such as | 200) High force is | 206) Fatigue limits maximum | 213) IJ26 |
| alloy | TiNi (also known as Nitinol — | available (stresses of | number of cycles | |
| | Nickel Titanium alloy developed | hundreds of MPa) | 207) Low strain (1%) is required to | |
| | at the Naval Ordnance | 201) Large strain is | extend fatigue resistance | |
| | Laboratory) is thermally switched | available (more than 3%) | 208) Cycle rate limited by heat | |
| | between its weak martensitic state | 202) High corrosion | removal | |
| | and its high stiffness austenic | resistance | 209) Requires unusual materials | |
| | state. The shape of the actuator in | 203) Simple construction | (TiNi) | |
| | its martensitic state is deformed | 204) Easy extension from | 210) The latent heat of | |
| | relative to the austenic shape. The | single nozzles to | transformation must be provided | |
| | shape change causes ejection of a | pagewidth print heads | 211) High current operation | |
| | drop. | 205) Low voltage | 212) Requires pre-stressing to | |
| | | operation | distort the martensitic state | |
| Linear | Linear magnetic actuators include | 214) Linear Magnetic | 218) Requires unusual | 222) IJ12 |
| Magnetic | the Linear Induction Actuator | actuators can be | semiconductor materials such as | |
| Actuator | (LIA), Linear Permanent Magnet | constructed with high | soft magnetic alloys (e.g. CoNiFe | |
| | Synchronous Actuator (LPMSA), | thrust, long travel, and | [1]) | |
| | Linear Reluctance Synchronous | high efficiency using | 219) Some varieties also require | |
| | Actuator (LRSA), Linear | planar semiconductor | permanent magnetic materials such | |
| | Switched Reluctance Actuator | fabrication techniques | as Neodymium iron boron (NdFeB) | |
| | (LSRA), and the Linear Stepper | 215) Long actuator travel | 220) Requires complex multi-phase | |
| | Actuator (LSA). | is available | drive circuitry | |
| | | 216) Medium force is | 221) High current operation | |
| | | available | | |
| | | 217) Low voltage | | |
| | | operation | | |

### Basic Operation Mode

| Operational | | | | |
|---|---|---|---|---|
| mode | Description | Advantages | Disadvantages | Examples |
| Actuator | This is the simplest mode of | 223) Simple operation | 227) Drop repetition rate is usually | 230) Thermal inkjet |
| directly | operation: the actuator directly | 224) No external fields | limited to less than 10 KHz. | 231) Piezoelectric |
| pushes ink | supplies sufficient kinetic energy | required | However, this is not fundamental to | inkjet |
| | to expel the drop. The drop must | 225) Satellite drops can | the method, but is related to the | 232) IJ01, IJ02, |
| | have a sufficient velocity to | be avoided if drop | refill method normally used | IJ03, IJ04 |
| | overcome the surface tension. | velocity is less than 4 m/s | 228) All of the drop kinetic energy | 233) IJ05, IJ06, |
| | | 226) Can be efficient, | must be provided by the actuator | IJ07, IJ09 |
| | | depending upon the | 229) Satellite drops usually form if | 234) IJ11, IJ12, |
| | | actuator used | drop velocity is greater than 4.5 m/s | IJ14, IJ16 |
| | | | | 235) IJ20, IJ22, |
| | | | | IJ23, IJ24 |
| | | | | 236) IJ25, IJ26, |
| | | | | IJ27, IJ28 |
| | | | | 237) IJ29, IJ30, |
| | | | | IJ31, IJ32 |
| | | | | 238) IJ33, IJ34, |
| | | | | IJ35, IJ36 |
| | | | | 239) IJ37, IJ38, |
| | | | | IJ39, IJ40 |
| | | | | 240) IJ41, IJ42, |
| | | | | IJ43, IJ44 |
| Proximity | The drops to be printed are | 241) Very simple print | 243) Requires close proximity | 246) Silverbrook, |
| | selected by some manner (e.g. | head fabrication can be | between the print head and the print | EP 0771 658 A2 |
| | thermally induced surface tension | used | media or transfer roller | and related patent |
| | reduction of pressurized ink). | 242) The drop selection | 244) May require two print heads | applications |
| | Selected drops are separated from | means does not need to | printing alternate rows of the image | |
| | the ink in the nozzle by contact | provide the energy | 245) Monolithic color print heads | |
| | with the print medium or a | required to separate the | are difficult | |
| | transfer roller. | drop from the nozzle | | |
| Electrostatic | The drops to be printed are | 247) Very simple print | 249) Requires very high | 252) Silverbrook, |
| pull on ink | selected by some manner (e.g. | head fabrication can be | electrostatic field | EP 0771 658 A2 |
| | thermally induced surface tension | used | 250) Electrostatic field for small | and related patent |
| | reduction of pressurized ink). | 248) The drop selection | nozzle sizes is above air breakdown | applications |
| | Selected drops are separated from | means does not need to | 251) Electrostatic field may attract | 253) Tone-Jet |
| | the ink in the nozzle by a strong | provide the energy | dust | |
| | electric field. | required to separate the | | |
| | | drop from the nozzle | | |
| Magnetic | The drops to be printed are | 254) Very simple print | 256) Requires magnetic ink | 259) Silverbrook, |
| pull on ink | selected by some manner (e.g. | head fabrication can be | 257) Ink colors other than black are | EP 0771 658 A2 |
| | thermally induced surface tension | used | difficult | and related patent |
| | reduction of pressurized ink). | 255) The drop selection | 258) Requires very high magnetic | applications |
| | Selected drops are separated from | means does not need to | fields | |
| | the ink in the nozzle by a strong | provide the energy | | |
| | magnetic field acting on the | required to separate the | | |
| | magnetic ink. | drop from the nozzle | | |
| Shutter | The actuator moves a shutter to | 260) High speed (>50 KHz) | 263) Moving parts are required | 267) IJ13, IJ17, |
| | block ink flow to the nozzle. The | operation can be | 264) Requires ink pressure | IJ21 |
| | ink pressure is pulsed at a | achieved due to reduced | modulator | |
| | multiple of the drop ejection | refill time | 265) Friction and wear must be | |
| | frequency. | 261) Drop timing can be | considered | |
| | | very accurate | 266) Stiction is possible | |
| | | 262) The actuator energy | | |
| | | can be very low | | |
| Shuttered | The actuator moves a shutter to | 268) Actuators with small | 271) Moving parts are required | 275) IJ08, IJ15, |
| grill | block ink flow through a grill to | travel can be used | 272) Requires ink pressure | IJ18, IJ19 |
| | the nozzle. The shutter movement | 269) Actuators with small | modulator | |
| | need only be equal to the width of | force can be used | 273) Friction and wear must be | |
| | the grill holes. | 270) High speed (>50 KHz) | considered | |
| | | operation can be | 274) Stiction is possible | |
| | | achieved | | |
| Pulsed | A pulsed magnetic field attracts | 276) Extremely low | 278) Requires an external pulsed | 281) IJ10 |
| magnetic | an ‘ink pusher’ at the drop | energy operation is | magnetic field | |
| pull on ink | ejection frequency. An actuator | possible | 279) Requires special materials for | |
| pusher | controls a catch, which prevents | 277) No heat dissipation | both the actuator and the ink pusher | |
| | the ink pusher from moving when | problems | 280) Complex construction | |
| | a drop is not to be ejected. | | | |

### Auxiliary Mechanism (Applied to All Nozzles)

| Auxiliary | | | | |
|---|---|---|---|---|
| Mechanism | Description | Advantages | Disadvantages | Examples |
| None | The actuator directly fires the ink | 282) Simplicity of | 285) Drop ejection energy must be | 286) Most inkjets, |
| | drop, and there is no external field | construction | supplied by individual nozzle | including |
| | or other mechanism required. | 283) Simplicity of | actuator | piezoelectric and |
| | | operation | | thermal bubble. |
| | | 284) Small physical size | | 287) IJ01-IJ07, |
| | | | | IJ09, IJ11 |
| | | | | 288) IJ12, IJ14, |
| | | | | IJ20, IJ22 |
| | | | | 289) IJ23-IJ45 |
| Oscillating ink | The ink pressure oscillates, | 290) Oscillating ink | 293) Requires external ink pressure | 296) Silverbrook, |
| pressure | providing much of the drop | pressure can provide a | oscillator | EP 0771 658 A2 |
| (including | ejection energy. The actuator | refill pulse, allowing | 294) Ink pressure phase and | and related patent |
| acoustic | selects which drops are to be fired | higher operating speed | amplitude must be carefully | applications |
| stimulation) | by selectively blocking or | 291) The actuators may | controlled | 297) IJ08, IJ13, |
| | enabling nozzles. The ink pressure | operate with much lower | 295) Acoustic reflections in the ink | IJ15, IJ17 |
| | oscillation may be achieved by | energy | chamber must be designed for | 298) IJ18, IJ19, |
| | vibrating the print head, or | 292) Acoustic lenses can | | IJ21 |
| | preferably by an actuator in the | be used to focus the | | |
| | ink supply. | sound on the nozzles | | |
| Media | The print head is placed in close | 299) Low power | 302) Precision assembly required | 305) Silverbrook, |
| proximity | proximity to the print medium. | 300) High accuracy | 303) Paper fibers may cause | EP 0771 658 A2 |
| | Selected drops protrude from the | 301) Simple print head | problems | and related patent |
| | print head further than unselected | construction | 304) Cannot print on rough | applications |
| | drops, and contact the print | | substrates | |
| | medium. The drop soaks into the | | | |
| | medium fast enough to cause drop | | | |
| | separation. | | | |
| Transfer roller | Drops are printed to a transfer | 306) High accuracy | 309) Bulky | 312) Silverbrook, |
| | roller instead of straight to the | 307) Wide range of print | 310) Expensive | EP 0771 658 A2 |
| | print medium. A transfer roller | substrates can be used | 311) Complex construction | and related patent |
| | can also be used for proximity | 308) Ink can be dried on | | applications |
| | drop separation. | the transfer roller | | 313) Tektronix |
| | | | | hot melt |
| | | | | piezoelectric |
| | | | | inkjet |
| | | | | 314) Any of the |
| | | | | IJ series |
| Electrostatic | An electric field is used to | 315) Low power | 317) Field strength required for | 318) Silverbrook, |
| | accelerate selected drops towards | 316) Simple print head | separation of small drops is near or | EP 0771 658 A2 |
| | the print medium. | construction | above air breakdown | and related patent |
| | | | | applications |
| | | | | 319) Tone-Jet |
| Direct | A magnetic field is used to | 320) Low power | 322) Requires magnetic ink | 324) Silverbrook, |
| magnetic field | accelerate selected drops of | 321) Simple print head | 323) Requires strong magnetic field | EP 0771 658 A2 |
| | magnetic ink towards the print | construction | | and related patent |
| | medium. | | | applications |
| Cross magnetic | The print head is placed in a | 325) Does not require | 326) Requires external magnet | 328) IJ06, IJ16 |
| field | constant magnetic field. The | magnetic materials to be | 327) Current densities may be high, | |
| | Lorenz force in a current carrying | integrated in the print | resulting in electromigration | |
| | wire is used to move the actuator. | head manufacturing | problems | |
| | | process | | |
| Pulsed | A pulsed magnetic field is used to | 329) Very low power | 331) Complex print head | 333) IJ10 |
| magnetic field | cyclically attract a paddle, which | operation is possible | construction | |
| | pushes on the ink. A small | 330) Small print head size | 332) Magnetic materials required in | |
| | actuator moves a catch, which | | print head | |
| | selectively prevents the paddle | | | |
| | from moving. | | | |

### Actuator Amplification or Modification Method

| Actuator | | | | |
|---|---|---|---|---|
| amplification | Description | Advantages | Disadvantages | Examples |
| None | No actuator mechanical | 334) Operational | 335) Many actuator mechanisms | 336) Thermal |
| | amplification is used. The actuator | simplicity | have insufficient travel, or | Bubble Inkjet |
| | directly drives the drop ejection | | insufficient force, to efficiently | 337) IJ01, IJ02, |
| | process. | | drive the drop ejection process | IJ06, IJ07 |
| | | | | 338) IJ16, IJ25, |
| | | | | IJ26 |
| Differential | An actuator material expands | 339) Provides greater | 341) High stresses are involved | 344) Piezoelectric |
| expansion | more on one side than on the | travel in a reduced print | 342) Care must be taken that the | 345) IJ03, IJ09, |
| bend actuator | other. The expansion may be | head area | materials do not delaminate | IJ17-IJ24 |
| | thermal, piezoelectric, | 340) The bend actuator | 343) Residual bend resulting from | 346) IJ27, IJ29-IJ39, |
| | magnetostrictive, or other mechanism. | converts a high force low | high temperature or high stress | IJ42, |
| | | travel actuator | during formation | 347) IJ43, IJ44 |
| | | mechanism to high travel, | | |
| | | lower force mechanism. | | |
| Transient bend | A trilayer bend actuator where the | 348) Very good | 351) High stresses are involved | 353) IJ40, IJ41 |
| actuator | two outside layers are identical. | temperature stability | 352) Care must be taken that the | |
| | This cancels bend due to ambient | 349) High speed, as a new | materials do not delaminate | |
| | temperature and residual stress. | drop can be fired before | | |
| | The actuator only responds to | heat dissipates | | |
| | transient heating of one side or the | 350) Cancels residual | | |
| | other. | stress of formation | | |
| Actuator stack | A series of thin actuators are | 354) Increased travel | 356) Increased fabrication | 358) Some |
| | stacked. This can be appropriate | 355) Reduced drive | complexity | piezoelectric ink |
| | where actuators require high | voltage | 357) Increased possibility of short | jets |
| | electric field strength, such as | | circuits due to pinholes | 359) IJ04 |
| | electrostatic and piezoelectric | | | |
| | actuators. | | | |
| Multiple | Multiple smaller actuators are | 360) Increases the force | 362) Actuator forces may not add | 363) IJ12, IJ13, |
| actuators | used simultaneously to move the | available from an actuator | linearly, reducing efficiency | IJ18, IJ20 |
| | ink. Each actuator need provide | 361) Multiple actuators | | 364) IJ22, IJ28, |
| | only a portion of the force | can be positioned to | | IJ42, IJ43 |
| | required. | control ink flow | | |
| | | accurately | | |
| Linear Spring | A linear spring is used to | 365) Matches low travel | 367) Requires print head area for the | 368) IJ15 |
| | transform a motion with small | actuator with higher | spring | |
| | travel and high force into a longer | travel requirements | | |
| | travel, lower force motion. | 366) Non-contact method | | |
| | | of motion transformation | | |
| Reverse spring | The actuator loads a spring. When | 369) Better coupling to | 370) Fabrication complexity | 372) IJ05, IJ11 |
| | the actuator is turned off, the | the ink | 371) High stress in the spring | |
| | spring releases. This can reverse | | | |
| | the force/distance curve of the | | | |
| | actuator to make it compatible | | | |
| | with the force/time requirements | | | |
| | of the drop ejection. | | | |
| Coiled | A bend actuator is coiled to | 373) Increases travel | 376) Generally restricted to planar | 377) IJ17, IJ21, |
| actuator | provide greater travel in a reduced | 374) Reduces integrated | implementations due to extreme | IJ34, IJ35 |
| | integrated circuit area. | circuit area | fabrication difficulty in other | |
| | | 375) Planar | orientations. | |
| | | implementations are | | |
| | | relatively easy to | | |
| | | fabricate. | | |
| Flexure bend | A bend actuator has a small | 378) Simple means of | 379) Care must be taken not to | 382) IJ10, IJ19, |
| actuator | region near the fixture point, | increasing travel of a | exceed the elastic limit in the | IJ33 |
| | which flexes much more readily | bend actuator | flexure area | |
| | than the remainder of the actuator. | | 380) Stress distribution is very | |
| | The actuator flexing is effectively | | uneven | |
| | convened from an even coiling to | | 381) Difficult to accurately model | |
| | an angular bend, resulting in | | with finite element analysis | |
| | greater travel of the actuator tip. | | | |
| Gears | Gears can be used to increase | 383) Low force, low | 385) Moving parts are required | 390) IJ13 |
| | travel at the expense of duration. | travel actuators can be | 386) Several actuator cycles are | |
| | Circular gears, rack and pinion, | used | required | |
| | ratchets, and other gearing | 384) Can be fabricated | 387) More complex drive | |
| | methods can be used. | using standard surface | electronics | |
| | | MEMS processes | 388) Complex construction | |
| | | | 389) Friction, friction, and wear are | |
| | | | possible | |
| Catch | The actuator controls a small | 391) Very low actuator | 393) Complex construction | 396) IJ10 |
| | catch. The catch either enables or | energy | 394) Requires external force | |
| | disables movement of an ink | 392) Very small actuator | 395) Unsuitable for pigmented inks | |
| | pusher that is controlled in a bulk | size | | |
| | manner. | | | |
| Buckle plate | A buckle plate can be used to | 397) Very fast movement | 398) Must stay within elastic limits | 401) S. Hirata et al, |
| | change a slow actuator into a fast | achievable | of the materials for long device life | “An Ink-jet Head . . . ”, |
| | motion. It can also convert a high | | 399) High stresses involved | Proc. IEEE |
| | force, low travel actuator into a | | 400) Generally high power | MEMS, February 1996, |
| | high travel, medium force motion. | | requirement | pp 418-423. |
| | | | | 402) IJ18, IJ27 |
| Tapered | A tapered magnetic pole can | 403) Linearizes the | 404) Complex construction | 405) IJ14 |
| magnetic pole | increase travel at the expense of | magnetic force/distance | | |
| | force. | curve | | |
| Lever | A lever and fulcrum is used to | 406) Matches low travel | 408) High stress around the fulcrum | 409) IJ32, IJ36, |
| | transform a motion with small | actuator with higher | | IJ37 |
| | travel and high force into a | travel requirements | | |
| | motion with longer travel and | 407) Fulcrum area has no | | |
| | lower force. The lever can also | linear movement, and can | | |
| | reverse the direction of travel. | be used for a fluid seal | | |
| Rotary | The actuator is connected to a | 410) High mechanical | 412) Complex construction | 414) IJ28 |
| impeller | rotary impeller. A small angular | advantage | 413) Unsuitable for pigmented inks | |
| | deflection of the actuator results | 411) The ratio of force to | | |
| | in a rotation of the impeller vanes, | travel of the actuator can | | |
| | which push the ink against | be matched to the nozzle | | |
| | stationary vanes and out of the | requirements by varying | | |
| | nozzle. | the number of impeller | | |
| | | vanes | | |
| Acoustic lens | A refractive or diffractive (e.g. | 415) No moving parts | 416) Large area required | 418) 1993 |
| | zone plate) acoustic lens is used to | | 417) Only relevant for acoustic ink | Hadimioglu et al, |
| | concentrate sound waves, | | jets | EUP 550,192 |
| | | | | 419) 1993 Elrod et |
| | | | | al, EUP 572,220 |
| Sharp | A sharp point is used to | 420) Simple construction | 421) Difficult to fabricate using | 423) Tone-jet |
| conductive | concentrate an electrostatic field. | | standard VLSI processes for a | |
| point | | | surface ejecting ink-jet | |
| | | | 422) Only relevant for electrostatic | |
| | | | ink jets | |

### Actuator Motion

| Actuator motion | Description | Advantages | Disadvantages | Examples |
|---|---|---|---|---|
| Volume | The volume of the actuator | 424) Simple construction | 425) High energy is typically | 426) Hewlett- |
| expansion | changes, pushing the ink in all | in the case of thermal ink | required to achieve volume | Packard Thermal |
| | directions. | jet | expansion. This leads to thermal | Inkjet |
| | | | stress, cavitation, and kogation in | 427) Canon |
| | | | thermal ink jet implementations | Bubblejet |
| Linear, normal | The actuator moves in a direction | 428) Efficient coupling to | 429) High fabrication complexity | 430) IJ01, IJ02, |
| to integrated | normal to the print head surface. | ink drops ejected normal | may be required to achieve | IJ04, IJ07 |
| circuit surface | The nozzle is typically in the line | to the surface | perpendicular motion | 431) IJ11, IJ14 |
| | of movement. | | | |
| Linear, | The actuator moves parallel to the | 432) Suitable for planar | 433) Fabrication complexity | 436) IJ12, IJ13, |
| parallel to | print head surface. Drop ejection | fabrication | 434) Friction | IJ15, IJ33, |
| integrated | may still be normal to the surface. | | 435) Stiction | 437) IJ34, IJ35, |
| circuit surface | | | | IJ36 |
| Membrane | An actuator with a high force but | 438) The effective area of | 439) Fabrication complexity | 442) 1982 Howkins |
| push | small area is used to push a stiff | the actuator becomes the | 440) Actuator size | U.S. Pat. No. 4,459,601 |
| | membrane that is in contact with | membrane area | 441) Difficulty of integration in a | |
| | the ink. | | VLSI process | |
| Rotary | The actuator causes the rotation of | 443) Rotary levers may | 445) Device complexity | 447) IJ05, IJ08, |
| | some element, such a grill or | be used to increase travel | 446) May have friction at a pivot | IJ13, IJ28 |
| | impeller | 444) Small integrated | point | |
| | | circuit area requirements | | |
| Bend | The actuator bends when | 448) A very small change | 449) Requires the actuator to be | 450) 1970 Kyser et |
| | energized. This may be due to | in dimensions can be | made from at least two distinct | al U.S. Pat. No. 3,946,398 |
| | differential thermal expansion, | converted to a large | layers, or to have a thermal | 451) 1973 Stemme |
| | piezoelectric expansion, | motion. | difference across the actuator | U.S. Pat. No. 3,747,120 |
| | magnetostriction, or other form of | | | 452) IJ03, IJ09, |
| | relative dimensional change. | | | IJ10, IJ19 |
| | | | | 453) IJ23, IJ24, |
| | | | | IJ25, IJ29 |
| | | | | 454) IJ30, IJ31, |
| | | | | IJ33, IJ34 |
| | | | | 455) IJ35 |
| Swivel | The actuator swivels around a | 456) Allows operation | 458) Inefficient coupling to the ink | 459) IJ06 |
| | central pivot. This motion is | where the net linear force | motion | |
| | suitable where there are opposite | on the paddle is zero | | |
| | forces applied to opposite sides of | 457) Small integrated | | |
| | the paddle, e.g. Lorenz force. | circuit area requirements | | |
| Straighten | The actuator is normally bent, and | 460) Can be used with | 461) Requires careful balance of | 462) IJ26, IJ32 |
| | straightens when energized. | shape memory alloys | stresses to ensure that the quiescent | |
| | | where the austenic phase | bend is accurate | |
| | | is planar | | |
| Double bend | The actuator bends in one | 463) One actuator can be | 466) Difficult to make the drops | 468) IJ36, IJ37, |
| | direction when one element is | used to power two | ejected by both bend directions | IJ38 |
| | energized, and bends the other | nozzles. | identical. | |
| | way when another element is | 464) Reduced integrated | 467) A small efficiency loss | |
| | energized. | circuit size. | compared to equivalent single bend | |
| | | 465) Not sensitive to | actuators. | |
| | | ambient temperature | | |
| Shear | Energizing the actuator causes a | 469) Can increase the | 470) Not readily applicable to other | 471) 1985 Fishbeck |
| | shear motion in the actuator | effective travel of | actuator mechanisms | U.S. Pat. No. 4,584,590 |
| | material. | piezoelectric actuators | | |
| Radial | The actuator squeezes an ink | 472) Relatively easy to | 473) High force required | 476) 1970 Zoltan |
| constriction | reservoir, forcing ink from a | fabricate single nozzles | 474) Inefficient | U.S. Pat. No. 3,683,212 |
| | constricted nozzle. | from glass tubing as | 475) Difficult to integrate with | |
| | | macroscopic structures | VLSI processes | |
| Coil/uncoil | A coiled actuator uncoils or coils | 477) Easy to fabricate as a | 479) Difficult to fabricate for non- | 481) IJ17, IJ21, |
| | more tightly. The motion of the | planar VLSI process | planar devices | IJ34, IJ35 |
| | free end of the actuator ejects the | 478) Small area required, | 480) Poor out-of-plane stiffness | |
| | ink. | therefore low cost | | |
| Bow | The actuator bows (or buckles) in | 482) Can increase the | 484) Maximum travel is constrained | 486) IJ16, IJ18, |
| | the middle when energized. | speed of travel | 485) High force required | IJ27 |
| | | 483) Mechanically rigid | | |
| Push-Pull | Two actuators control a shutter. | 487) The structure is | 488) Not readily suitable for inkjets | 489) IJ18 |
| | One actuator pulls the shutter, and | pinned at both ends, so | which directly push the ink | |
| | the other pushes it. | has a high out-of-plane | | |
| | | rigidity | | |
| Curl inwards | A set of actuators curl inwards to | 490) Good fluid flow to | 491) Design complexity | 492) IJ20, IJ42 |
| | reduce the volume of ink that they | the region behind the | | |
| | enclose. | actuator increases | | |
| | | efficiency | | |
| Curl outwards | A set of actuators curl outwards, | 493) Relatively simple | 494) Relatively large integrated | 495) IJ43 |
| | pressurizing ink in a chamber | construction | circuit area | |
| | surrounding the actuators, and | | | |
| | expelling ink from a nozzle in the | | | |
| | chamber. | | | |
| Iris | Multiple vanes enclose a volume | 496) High efficiency | 498) High fabrication complexity | 500) IJ22 |
| | of ink. These simultaneously | 497) Small integrated | 499) Not suitable for pigmented | |
| | rotate, reducing the volume | circuit area | inks | |
| | between the vanes. | | | |
| Acoustic | The actuator vibrates at a high | 501) The actuator can be | 502) Large area required for | 506) 1993 |
| vibration | frequency. | physically distant from | efficient operation at useful | Hadimioglu et al, |
| | | the ink | frequencies | EUP 550,192 |
| | | | 503) Acoustic coupling and | 507) 1993 Elrod et |
| | | | crosstalk | al, EUP 572,220 |
| | | | 504) Complex drive circuitry | |
| | | | 505) Poor control of drop volume | |
| | | | and position | |
| None | In various ink jet designs the | 508) No moving parts | 509) Various other tradeoffs are | 510) Silverbrook, |
| | actuator does not move. | | required to eliminate moving parts | EP 0771 658 A2 |
| | | | | and related patent |
| | | | | applications |
| | | | | 511) Tone-jet |

### Nozzle Refill Method

| Nozzle refill | | | | |
|---|---|---|---|---|
| method | Description | Advantages | Disadvantages | Examples |
| Surface tension | After the actuator is energized, it | 512) Fabrication | 514) Low speed | 517) Thermal inkjet |
| | typically returns rapidly to its | simplicity | 515) Surface tension force relatively | 518) Piezoelectric |
| | normal position. This rapid return | 513) Operational | small compared to actuator force | inkjet |
| | sucks in air through the nozzle | simplicity | 516) Long refill time usually | 519) IJ01-IJ07, |
| | opening. The ink surface tension | | dominates the total repetition rate | IJ10-IJ14 |
| | at the nozzle then exerts a small | | | 520) IJ16, IJ20, |
| | force restoring the meniscus to a | | | IJ22-IJ45 |
| | minimum area. | | | |
| Shuttered | Ink to the nozzle chamber is | 521) High speed | 523) Requires common ink pressure | 525) IJ08, IJ13, |
| oscillating ink | provided at a pressure that | 522) Low actuator | oscillator | IJ15, IJ17 |
| pressure | oscillates at twice the drop | energy, as the actuator | 524) May not be suitable for | 526) IJ18, IJ19, |
| | ejection frequency. When a drop | need only open or close | pigmented inks | IJ21 |
| | is to be ejected, the shutter is | the shutter, instead of | | |
| | opened for 3 half cycles: drop | ejecting the ink drop | | |
| | ejection, actuator return, and | | | |
| | refill. | | | |
| Refill actuator | After the main actuator has | 527) High speed, as the | 528) Requires two independent | 529) IJ09 |
| | ejected a drop a second (refill) | nozzle is actively refilled | actuators per nozzle | |
| | actuator is energized. The refill | | | |
| | actuator pushes ink into the nozzle | | | |
| | chamber. The refill actuator | | | |
| | returns slowly, to prevent its | | | |
| | return from emptying the chamber | | | |
| | again. | | | |
| Positive ink | The ink is held a slight positive | 530) High refill rate, | 531) Surface spill must be prevented | 533) Silverbrook, |
| pressure | pressure. After the ink drop is | therefore a high drop | 532) Highly hydrophobic print head | EP 0771 658 A2 |
| | ejected, the nozzle chamber fills | repetition rate is possible | surfaces are required | and related patent |
| | quickly as surface tension and ink | | | applications |
| | pressure both operate to refill the | | | 534) Alternative |
| | nozzle. | | | for: |
| | | | | 535) IJ01-IJ07, |
| | | | | IJ10-IJ14 |
| | | | | 536) IJ16, IJ20, |
| | | | | IJ22-IJ45 |

### Method of Restricting Back-Flow Through Inlet

| Inlet back-flow | | | | |
|---|---|---|---|---|
| restriction | | | | |
| method | Description | Advantages | Disadvantages | Examples |
| Long inlet | The ink inlet channel to the nozzle | 537) Design simplicity | 540) Restricts refill rate | 543) Thermal inkjet |
| channel | chamber is made long and | 538) Operational | 541) May result in a relatively large | 544) Piezoelectric |
| | relatively narrow, relying on | simplicity | integrated circuit area | inkjet |
| | viscous drag to reduce inlet back- | 539) Reduces crosstalk | 542) Only partially effective | 545) IJ42, IJ43 |
| | flow. | | | |
| Positive ink | The ink is under a positive | 546) Drop selection and | 548) Requires a method (such as a | 549) Silverbrook, |
| pressure | pressure, so that in the quiescent | separation forces can be | nozzle rim or effective | EP 0771 658 A2 |
| | state some of the ink drop already | reduced | hydrophobizing, or both) to prevent | and related patent |
| | protrudes from the nozzle. | 547) Fast refill time | flooding of the ejection surface of | applications |
| | This reduces the pressure in the | | the print head. | 550) Possible |
| | nozzle chamber which is required | | | operation of the |
| | to eject a certain volume of ink. | | | following: |
| | The reduction in chamber | | | 551) IJ01-IJ07, |
| | pressure results in a reduction in | | | IJ09-IJ12 |
| | ink pushed out through the inlet. | | | 552) IJ14, IJ16, |
| | | | | IJ20, IJ22, |
| | | | | 553) IJ23-IJ34, |
| | | | | IJ36-IJ41 |
| | | | | 554) IJ44 |
| Baffle | One or more baffles are placed in | 555) The refill rate is not | 557) Design complexity | 559) HP Thermal |
| | the inlet ink flow. When the | as restricted as the long | 558) May increase fabrication | Ink Jet |
| | actuator is energized, the rapid ink | inlet method. | complexity (e.g. Tektronix hot melt | 560) Tektronix |
| | movement creates eddies which | 556) Reduces crosstalk | Piezoelectric print heads). | piezoelectric ink jet |
| | restrict the flow through the inlet. | | | |
| | The slower refill process is | | | |
| | unrestricted, and does not result in | | | |
| | eddies. | | | |
| Flexible flap | In this method recently disclosed | 561) Significantly | 562) Not applicable to most inkjet | 565) Canon |
| restricts inlet | by Canon, the expanding actuator | reduces back-flow | configurations | |
| | (bubble) pushes on a flexible flap | for edge-shooter | 563) Increased fabrication | |
| | that restricts the inlet. | thermal ink jet devices | complexity | |
| | | | 564) Inelastic deformation of | |
| | | | polymer flap results in creep over | |
| | | | extended use | |
| Inlet filter | A filter is located between the ink | 566) Additional | 568) Restricts refill rate | 570) IJ04, IJ12, |
| | inlet and the nozzle chamber. The | advantage of ink | 569) May result in complex | IJ24, IJ27 |
| | filter has a multitude of small | filtration | construction | 571) IJ29, IJ30 |
| | holes or slots, restricting ink flow. | 567) Ink filter may be | | |
| | The filter also removes particles | fabricated with no | | |
| | which may block the nozzle. | additional process steps | | |
| Small inlet | The ink inlet channel to the nozzle | 572) Design simplicity | 573) Restricts refill rate | 576) IJ02, IJ37, |
| compared to | chamber has a substantially | | 574) May result in a relatively | IJ44 |
| nozzle | smaller cross section than that of | | large integrated circuit area | |
| | the nozzle, resulting in easier ink | | 575) Only partially effective | |
| | egress out of the nozzle than out | | | |
| | of the inlet. | | | |
| Inlet shutter | A secondary actuator controls the | 577) Increases speed of | 578) Requires separate refill | 579) IJ09 |
| | position of a shutter, closing off | the ink-jet print head | actuator and drive circuit | |
| | the ink inlet when the main | operation | | |
| | actuator is energized. | | | |
| The inlet is | The method avoids the problem of | 580) Back-flow problem | 581) Requires careful design to | 582) IJ01, IJ03, |
| located behind | inlet back-flow by arranging the | is eliminated | minimize the negative pressure | IJ05, IJ06 |
| the ink- | ink-pushing surface of the | | behind the paddle | 583) IJ07, IJ10, |
| pushing | actuator between the inlet and the | | | IJ11, IJ14 |
| surface | nozzle. | | | 584) IJ16, IJ22, |
| | | | | IJ23, IJ25 |
| | | | | 585) IJ28, IJ31, |
| | | | | IJ32, IJ33 |
| | | | | 586) IJ34, IJ35, |
| | | | | IJ36, IJ39 |
| | | | | 587) IJ40, IJ41 |
| Part of the | The actuator and a wall of the ink | 588) Significant | 590) Small increase in fabrication | 591) IJ07, IJ20, |
| actuator moves | chamber are arranged so that the | reductions in back-flow | complexity | IJ26, IJ38 |
| to shut off the | motion of the actuator closes off | can be achieved | | |
| inlet | the inlet. | 589) Compact designs | | |
| | | possible | | |
| Nozzle | In some configurations of ink jet, | 592) Ink back-flow | 593) None related to ink back-flow | 594) Silverbrook, |
| actuator does | there is no expansion or | problem is eliminated | on actuation | EP 0771 658 A2 |
| not result in | movement of an actuator which | | | and related patent |
| ink back-flow | may cause ink back-flow through | | | applications |
| | the inlet. | | | 595) Valve-jet |
| | | | | 596) Tone-jet |
| | | | | 597) IJ08, IJ13, |
| | | | | IJ15, IJ17 |
| | | | | 598) IJ18, IJ19, |
| | | | | IJ21 |

### Nozzle Clearing Method

| Nozzle | | | | |
|---|---|---|---|---|
| Clearing | | | | |
| method | Description | Advantages | Disadvantages | Examples |
| Normal nozzle | All of the nozzles are fired | 599) No added | 600) May not be sufficient to | 601) Most ink jet |
| firing | periodically, before the ink has a | complexity on the print | displace dried ink | systems |
| | chance to dry. When not in use | head | | 602) IJ01-IJ07, |
| | the nozzles are sealed (capped) | | | IJ09-IJ12 |
| | against air. | | | 603) IJ14, IJ16, |
| | The nozzle firing is usually | | | IJ20, IJ22 |
| | performed during a special | | | 604) IJ23-IJ34, |
| | clearing cycle, after first moving | | | IJ36-IJ45 |
| | the print head to a cleaning | | | |
| | station. | | | |
| Extra power to | In systems which heat the ink, but | 605) Can be highly | 606) Requires higher drive voltage | 608) Silverbrook, |
| ink heater | do not boil it under normal | effective if the heater is | for clearing | EP 0771 658 A2 |
| | situations, nozzle clearing can be | adjacent to the nozzle | 607) May require larger drive | and related patent |
| | achieved by over-powering the | | transistors | applications |
| | heater and boiling ink at the | | | |
| | nozzle. | | | |
| Rapid | The actuator is fired in rapid | 609) Does not require | 611) Effectiveness depends | 612) May be used |
| succession of | succession. In some | extra drive circuits on the | substantially upon the configuration | with: |
| actuator pulses | configurations, this may cause | print head | of the inkjet nozzle | 613) IJ01-IJ07, |
| | heat build-up at the nozzle which | 610) Can be readily | | IJ09-IJ11 |
| | boils the ink, clearing the nozzle. | controlled and initiated | | 614) IJ14, IJ16, |
| | In other situations, it may cause | by digital logic | | IJ20, IJ22 |
| | sufficient vibrations to dislodge | | | 615) IJ23-IJ25, |
| | clogged nozzles. | | | IJ27-IJ34 |
| | | | | 616) IJ36-IJ45 |
| Extra power to | Where an actuator is not normally | 617) A simple solution | 618) Not suitable where there is a | 619) May be used |
| ink pushing | driven to the limit of its motion, | where applicable | hard limit to actuator movement | with: |
| actuator | nozzle clearing may be assisted by | | | 620) IJ03, IJ09, |
| | providing an enhanced drive | | | IJ16, IJ20 |
| | signal to the actuator. | | | 621) IJ23, IJ24, |
| | | | | IJ25, IJ27 |
| | | | | 622) IJ29, IJ30, |
| | | | | IJ31, IJ32 |
| | | | | 623) IJ39, IJ40, |
| | | | | IJ41, IJ42 |
| | | | | 624) IJ43, IJ44, |
| | | | | IJ45 |
| Acoustic | An ultrasonic wave is applied to | 625) A high nozzle | 627) High implementation cost if | 628) IJ08, IJ13, |
| resonance | the ink chamber. This wave is of | clearing capability can be | system does not already include an | IJ15, IJ17 |
| | an appropriate amplitude and | achieved | acoustic actuator | 629) IJ18, IJ19, |
| | frequency to cause sufficient force | 626) May be implemented | | IJ21 |
| | at the nozzle to clear blockages. | at very low cost in | | |
| | This is easiest to achieve if the | systems which already | | |
| | ultrasonic wave is at a resonant | include acoustic actuators | | |
| | frequency of the ink cavity. | | | |
| Nozzle clearing | A microfabricated plate is pushed | 630) Can clear severely | 631) Accurate mechanical | 635) Silverbrook, |
| plate | against the nozzles. The plate has | clogged nozzles | alignment is required | EP 0771 658 A2 |
| | a post for every nozzle. The array | | 632) Moving parts are required | and related patent |
| | of posts | | 633) There is risk of damage to the | applications |
| | | | nozzles | |
| | | | 634) Accurate fabrication is | |
| | | | required | |
| Ink pressure | The pressure of the ink is | 636) May be effective | 637) Requires pressure pump or | 640) May be used |
| pulse | temporarily increased so that ink | where other methods | other pressure actuator | with all IJ series |
| | streams from all of the nozzles. | cannot be used | 638) Expensive | ink jets |
| | This may be used in conjunction | | 639) Wasteful of ink | |
| | with actuator energizing. | | | |
| Print head | A flexible ‘blade’ is wiped across | 641) Effective for planar | 643) Difficult to use if print head | 646) Many ink jet |
| wiper | the print head surface. The blade | print head surfaces | surface is non-planar or very fragile | systems |
| | is usually fabricated from a | 642) Low cost | 644) Requires mechanical parts | |
| | flexible polymer, e.g. rubber or | | 645) Blade can wear out in high | |
| | synthetic elastomer. | | volume print systems | |
| Separate ink | A separate heater is provided at | 647) Can be effective | 649) Fabrication complexity | 650) Can be used |
| boiling heater | the nozzle although the normal | where other nozzle | | with many IJ |
| | drop e-ection mechanism does | clearing methods cannot | | series ink jets |
| | not require it. The heaters do not | be used | | |
| | require individual drive circuits, | 648) Can be implemented | | |
| | as many nozzles can be cleared | at no additional cost in | | |
| | simultaneously, and no imaging is | some inkjet | | |
| | required. | configurations | | |

### Nozzle Plate Construction

| Nozzle plate | | | | |
|---|---|---|---|---|
| construction | Description | Advantages | Disadvantages | Examples |
| Electroformed | A nozzle plate is separately | 651) Fabrication | 652) High temperatures and | 655) Hewlett |
| nickel | fabricated from electroformed | simplicity | pressures are required to bond | Packard Thermal |
| | nickel, and bonded to the print | | nozzle plate | Inkjet |
| | head integrated circuit. | | 653) Minimum thickness constraints | |
| | | | 654) Differential thermal expansion | |
| Laser ablated | Individual nozzle holes are | 656) No masks required | 660) Each hole must be individually | 664) Canon |
| or drilled | ablated by an intense UV laser in | 657) Can be quite fast | formed | Bubblejet |
| polymer | a nozzle plate, which is typically a | 658) Some control over | 661) Special equipment required | 665) 1988 Sercel et |
| | polymer such as polyimide or | nozzle profile is possible | 662) Slow where there are many | al., SPIE, Vol. 998 |
| | polysulphone | 659) Equipment required | thousands of nozzles per print head | Excimer Beam |
| | | is relatively low cost | 663) May produce thin burrs at exit | Applications, pp. |
| | | | holes | 76-83 |
| | | | | 666) 1993 |
| | | | | Watanabe et al., |
| | | | | U.S. Pat. No. 5,208,604 |
| Silicon micro- | A separate nozzle plate is | 667) High accuracy is | 668) Two part construction | 672) K. Bean, IEEE |
| machined | micromachined from single | attainable | 669) High cost | Transactions on |
| | crystal silicon, and bonded to the | | 670) Requires precision alignment | Electron Devices, |
| | print head wafer. | | 671) Nozzles may be clogged by | Vol. ED-25, No. 10, |
| | | | adhesive | 1978, pp 1185-1195 |
| | | | | 673) Xerox 1990 |
| | | | | Hawkins et al., U.S. Pat. |
| | | | | No. 4,899,181 |
| Glass | Fine glass capillaries are drawn | 674) No expensive | 676) Very small nozzle sizes are | 678) 1970 Zoltan |
| capillaries | from glass tubing. This method | equipment required | difficult to form | U.S. Pat. No. 3,683,212 |
| | has been used for making | 675) Simple to make | 677) Not suited for mass production | |
| | individual nozzles, but is difficult | single nozzles | | |
| | to use for bulk manufacturing of | | | |
| | print heads with thousands of | | | |
| | nozzles. | | | |
| Monolithic, | The nozzle plate is deposited as a | 679) High accuracy (<1 μm) | 683) Requires sacrificial layer under | 685) Silverbrook, |
| surface micro- | layer using standard VLSI | 680) Monolithic | the nozzle plate to form the nozzle | EP 0771 658 A2 |
| machined | deposition techniques. Nozzles | 681) Low cost | chamber | and related patent |
| using VLSI | are etched in the nozzle plate | 682) Existing processes | 684) Surface may be fragile to the | applications |
| lithographic | using VLSI lithography and | can be used | touch | 686) IJ01, IJ02, |
| processes | etching. | | | IJ04, IJ11 |
| | | | | 687) IJ12, IJ17, |
| | | | | IJ18, IJ20 |
| | | | | 688) IJ22, IJ24, |
| | | | | IJ27, IJ28 |
| | | | | 689) IJ29, IJ30, |
| | | | | IJ31, IJ32 |
| | | | | 690) IJ33, IJ34, |
| | | | | IJ36, IJ37 |
| | | | | 691) IJ38, IJ39, |
| | | | | IJ40, IJ41 |
| | | | | 692) IJ42, IJ43, |
| | | | | IJ44 |
| Monolithic, | The nozzle plate is a buried etch | 693) High accuracy (<1 μm) | 697) Requires long etch times | 699) IJ03, IJ05, |
| etched through | stop in the wafer. Nozzle | 694) Monolithic | 698) Requires a support wafer | IJ06, IJ07 |
| substrate | chambers are etched in the front | 695) Low cost | | 700) IJ08, IJ09, |
| | of the wafer, and the wafer is | 696) No differential | | IJ10, IJ13 |
| | thinned from the back side. | expansion | | 701) IJ14, IJ15, |
| | Nozzles are then etched in the | | | IJ16, IJ19 |
| | etch stop layer. | | | 702) IJ21, IJ23, |
| | | | | IJ25, IJ26 |
| No nozzle plate | Various methods have been tried | 703) No nozzles to | 704) Difficult to control drop | 706) Ricoh 1995 |
| | to eliminate the nozzles entirely, | become clogged | position accurately | Sekiya et al U.S. Pat. No. |
| | to prevent nozzle clogging. These | | 705) Crosstalk problems | 5,412,413 |
| | include thermal bubble | | | 707) 1993 |
| | mechanisms and acoustic lens | | | Hadimioglu et al |
| | mechanisms | | | EUP 550,192 |
| | | | | 708) 1993 Elrod et |
| | | | | al EUP 572,220 |
| Trough | Each drop ejector has a trough | 709) Reduced | 711) Drop firing direction is | 712) IJ35 |
| | through which a paddle moves, | manufacturing | sensitive to wicking. | |
| | There is no nozzle plate. | complexity | | |
| | | 710) Monolithic | | |
| Nozzle slit | The elimination of nozzle holes | 713) No nozzles to | 714) Difficult to control drop | 716) 1989 Saito et |
| instead of | and replacement by a slit | become clogged | position accurately | al U.S. Pat. No. 4,799,068 |
| individual | encompassing many actuator | | 715) Crosstalk problems | |
| nozzles | positions reduces nozzle clogging, | | | |
| | but increases crosstalk due to ink | | | |
| | surface waves | | | |

### Drop Ejection Direction

| Ejection | | | | |
|---|---|---|---|---|
| direction | Description | Advantages | Disadvantages | Examples |
| Edge | Ink flow is along the surface of | 717) Simple construction | 722) Nozzles limited to edge | 725) Canon |
| (‘edge | the integrated circuit, and ink | 718) No silicon etching | 723) High resolution is difficult | Bubblejet 1979 |
| shooter’) | drops are ejected from the | required | 724) Fast color printing requires one | Endo et al GB |
| | integrated circuit edge. | 719) Good heat sinking | print head per color | patent 2,007,162 |
| | | via substrate | | 726) Xerox heater- |
| | | 720) Mechanically strong | | in-pit 1990 |
| | | 721) Ease of integrated | | Hawkins et al U.S. Pat. No. |
| | | circuit handing | | 4,899,181 |
| | | | | 727) Tone-jet |
| Surface | Ink flow is along the surface of | 728) No bulk silicon | 731) Maximum ink flow is severely | 732) Hewlett- |
| (‘roof shooter’) | the integrated circuit, and ink | etching required | restricted | Packard TIJ 1982 |
| | drops are ejected from the | 729) Silicon can make an | | Vaught et al U.S. Pat. No. |
| | integrated circuit surface, normal | effective heat sink | | 4,490,728 |
| | to the plane of the integrated | 730) Mechanical strength | | 733) IJ02, IJ11, |
| | circuit. | | | IJ12, IJ20 |
| | | | | 734) IJ22 |
| Through | Ink flow is through the integrated | 735) High ink flow | 738) Requires bulk silicon etching | 739) Silverbrook, |
| integrated | circuit, and ink drops are ejected | 736) Suitable for | | EP 0771 658 A2 |
| circuit, | from the front surface of the | pagewidth print | | and related patent |
| forward | integrated circuit. | 737) High nozzle packing | | applications |
| (‘up shooter’) | density therefore low | | | 740) IJ04, IJ17, |
| | manufacturing cost | | | IJ18, IJ24 |
| | | | | 741) IJ27-IJ45 |
| Through | Ink flow is through the integrated | 742) High ink flow | 745) Requires wafer thinning | 747) IJ01, IJ03, |
| integrated | circuit, and ink drops are ejected | 743) Suitable for | 746) Requires special handling | IJ05, IJ06 |
| circuit, reverse | from the rear surface of the | pagewidth print | during manufacture | 748) IJ07, IJ08, |
| (‘down | integrated circuit. | 744) High nozzle packing | | IJ09, IJ10 |
| shooter’) | density therefore low | | | 749) IJ13, IJ14, |
| | manufacturing cost | | | IJ15, IJ16 |
| | | | | 750) IJ19, IJ21, |
| | | | | IJ23, IJ25 |
| | | | | 751) IJ26 |
| Through | Ink flow is through the actuator, | 752) Suitable for | 753) Pagewidth print heads require | 756) Epson Stylus |
| actuator | which is not fabricated as part of | piezoelectric print heads | several thousand connections to | 757) Tektronix hot |
| | the same substrate as the drive | | drive circuits | melt piezoelectric |
| | transistors. | | 754) Cannot be manufactured in | ink jets |
| | | | standard CMOS fabs | |
| | | | 755) Complex assembly required | |

### Ink Type

| Ink type | Description | Advantages | Disadvantages | Examples |
|---|---|---|---|---|
| Aqueous, dye | Water based ink which typically | 758) Environmentally | 760) Slow drying | 765) Most existing |
| | contains: water, dye, surfactant, | friendly | 761) Corrosive | inkjets |
| | humectant, and biocide. | 759) No odor | 762) Bleeds on paper | 766) All IJ series |
| | Modern ink dyes have high water- | | 763) May strikethrough | ink jets |
| | fastness, light fastness | | 764) Cockles paper | 767) Silverbrook, |
| | | | | EP 0771 658 A2 |
| | | | | and related patent |
| | | | | applications |
| Aqueous, | Water based ink which typically | 768) Environmentally | 773) Slow drying | 778) IJ02, IJ04, |
| pigment | contains: water, pigment, | friendly | 774) Corrosive | IJ21, IJ26 |
| | surfactant, humectant, and | 769) No odor | 775) Pigment may clog nozzles | 779) IJ27, IJ30 |
| | biocide. | 770) Reduced bleed | 776) Pigment may clog actuator | 780) Silverbrook, |
| | Pigments have an advantage in | 771) Reduced wicking | mechanisms | EP 0771 658 A2 |
| | reduced bleed, wicking and | 772) Reduced | 777) Cockles paper | and related patent |
| | strikethrough. | strikethrough | | applications |
| | | | | 781) Piezoelectric |
| | | | | ink-jets |
| | | | | 782) Thermal ink |
| | | | | jets (with |
| | | | | significant |
| | | | | restrictions) |
| Methyl Ethyl | MEK is a highly volatile solvent | 783) Very fast drying | 785) Odorous | 787) All IJ series |
| Ketone (MEK) | used for industrial printing on | 784) Prints on various | 786) Flammable | ink jets |
| | difficult surfaces such as | substrates such as metals | | |
| | aluminum cans. | and plastics | | |
| Alcohol | Alcohol based inks can be used | 788) Fast drying | 792) Slight odor | 794) All IJ series |
| (ethanol, 2- | where the printer must operate at | 789) Operates at sub- | 793) Flammable | ink jets |
| butanol, and | temperatures below the freezing | freezing temperatures | | |
| others) | point of water. An example of this | 790) Reduced paper | | |
| | is in-camera consumer | cockle | | |
| | photographic printing. | 791) Low cost | | |
| Phase change | The ink is solid at room | 795) No drying time-ink | 801) High viscosity | 807) Tektronix hot |
| (hot melt) | temperature, and is melted in the | instantly freezes on the | 802) Printed ink typically has a | melt piezoelectric |
| | print head before jetting. Hot melt | print medium | ‘waxy’ feel | ink jets |
| | inks are usually wax based, with a | 796) Almost any print | 803) Printed pages may ‘block’ | 808) 1989 Nowak |
| | melting point around 80° C. After | medium can be used | 804) Ink temperature may be above | U.S. Pat. No. |
| | jetting the ink freezes almost | 797) No paper cockle | the curie point of permanent | 4,820,346 |
| | instantly upon contacting the print | occurs | magnets | 809) All IJ series |
| | medium or a transfer roller. | 798) No wicking occurs | 805) Ink heaters consume power | ink jets |
| | | 799) No bleed occurs | 806) Long warm-up time | |
| | | 800) No strikethrough | | |
| | | occurs | | |
| Oil | Oil based inks are extensively | 810) High solubility | 813) High viscosity: this is a | 815) All IJ series |
| | used in offset printing. They have | medium for some dyes | significant limitation for use in | ink jets |
| | advantages in improved | 811) Does not cockle | inkjets, which usually require a low | |
| | characteristics on paper | paper | viscosity. Some short chain and | |
| | (especially no wicking or cockle). | 812) Does not wick | multi-branched oils have a | |
| | Oil soluble dies and pigments are | through paper | sufficiently low viscosity. | |
| | required. | | 814) Slow drying | |
| Microemulsion | A microemulsion is a stable, self | 816) Stops ink bleed | 820) Viscosity higher than water | 823) All IJ series |
| | forming emulsion of oil, water, | 817) High dye solubility | 821) Cost is slightly higher than | ink jets |
| | and surfactant. The characteristic | 818) Water, oil, and | water based ink | |
| | drop size is less than 100 nm, and | amphiphilic soluble dies | 822) High surfactant concentration | |
| | is determined by the preferred | can be used | required (around 5%) | |
| | curvature of the surfactant. | 819) Can stabilize | | |
| | | pigment suspensions | | |

### Ink Jet Printing

A large number of new forms of ink jet printers have been developed to facilitate alternative ink jet technologies for the image processing and data distribution system. Various combinations of ink jet devices can be included in printer devices incorporated as part of the present invention. Australian Provisional Patent Applications relating to these ink jets which are specifically incorporated by cross reference. The serial numbers of respective corresponding US patent applications are also provided for the sake of convenience.

| Australian | | | US Patent/Patent |
|---|---|---|---|
| Provisional | | | Application and Filing |
| Number | Filing Date | Title | Date |
| PO8066 | 15-Jul-97 | Image Creation Method and Apparatus | 6,227,652 |
| | | (IJ01) | (Jul. 10, 1998) |
| PO8072 | 15-Jul-97 | Image Creation Method and Apparatus | 6,213,588 |
| | | (IJ02) | (Jul. 10, 1998) |
| PO8040 | 15-Jul-97 | Image Creation Method and Apparatus | 6,213,589 |
| | | (IJ03) | (Jul. 10, 1998) |
| PO8071 | 15-Jul-97 | Image Creation Method and Apparatus | 6,231,163 |
| | | (IJ04) | (Jul. 10, 1998) |
| PO8047 | 15-Jul-97 | Image Creation Method and Apparatus | 6,247,795 |
| | | (IJ05) | (Jul. 10, 1998) |
| PO8035 | 15-Jul-97 | Image Creation Method and Apparatus | 6,394,581 |
| | | (IJ06) | (Jul. 10, 1998) |
| PO8044 | 15-Jul-97 | Image Creation Method and Apparatus | 6,244,691 |
| | | (IJ07) | (Jul. 10, 1998) |
| PO8063 | 15-Jul-97 | Image Creation Method and Apparatus | 6,257,704 |
| | | (IJ08) | (Jul. 10, 1998) |
| PO8057 | 15-Jul-97 | Image Creation Method and Apparatus | 6,416,168 |
| | | (IJ09) | (Jul. 10, 1998) |
| PO8056 | 15-Jul-97 | Image Creation Method and Apparatus | 6,220,694 |
| | | (IJ10) | (Jul. 10, 1998) |
| PO8069 | 15-Jul-97 | Image Creation Method and Apparatus | 6,257,705 |
| | | (IJ11) | (Jul. 10, 1998) |
| PO8049 | 15-Jul-97 | Image Creation Method and Apparatus | 6,247,794 |
| | | (IJ12) | (Jul. 10, 1998) |
| PO8036 | 15-Jul-97 | Image Creation Method and Apparatus | 6,234,610 |
| | | (IJ13) | (Jul. 10, 1998) |
| PO8048 | 15-Jul-97 | Image Creation Method and Apparatus | 6,247,793 |
| | | (IJ14) | (Jul. 10, 1998) |
| PO8070 | 15-Jul-97 | Image Creation Method and Apparatus | 6,264,306 |
| | | (IJ15) | (Jul. 10, 1998) |
| PO8067 | 15-Jul-97 | Image Creation Method and Apparatus | 6,241,342 |
| | | (IJ16) | (Jul. 10, 1998) |
| PO8001 | 15-Jul-97 | Image Creation Method and Apparatus | 6,247,792 |
| | | (IJ17) | (Jul. 10, 1998) |
| PO8038 | 15-Jul-97 | Image Creation Method and Apparatus | 6,264,307 |
| | | (IJ18) | (Jul. 10, 1998) |
| PO8033 | 15-Jul-97 | Image Creation Method and Apparatus | 6,254,220 |
| | | (IJ19) | (Jul. 10, 1998) |
| PO8002 | 15-Jul-97 | Image Creation Method and Apparatus | 6,234,611 |
| | | (IJ20) | (Jul. 10, 1998) |
| PO8068 | 15-Jul-97 | Image Creation Method and Apparatus | 6,302,528) |
| | | (IJ21) | (Jul. 10, 1998) |
| PO8062 | 15-Jul-97 | Image Creation Method and Apparatus | 6,283,582 |
| | | (IJ22) | (Jul. 10, 1998) |
| PO8034 | 15-Jul-97 | Image Creation Method and Apparatus | 6,239,821 |
| | | (IJ23) | (Jul. 10, 1998) |
| PO8039 | 15-Jul-97 | Image Creation Method and Apparatus | 6,338,547 |
| | | (IJ24) | (Jul. 10, 1998) |
| PO8041 | 15-Jul-97 | Image Creation Method and Apparatus | 6,247,796 |
| | | (IJ25) | (Jul. 10, 1998) |
| PO8004 | 15-Jul-97 | Image Creation Method and Apparatus | 09/113,122 |
| | | (IJ26) | (Jul. 10, 1998) |
| PO8037 | 15-Jul-97 | Image Creation Method and Apparatus | 6,390,603 |
| | | (IJ27) | (Jul. 10, 1998) |
| PO8043 | 15-Jul-97 | Image Creation Method and Apparatus | 6,362,843 |
| | | (IJ28) | (Jul. 10, 1998) |
| PO8042 | 15-Jul-97 | Image Creation Method and Apparatus | 6,293,653 |
| | | (IJ29) | (Jul. 10, 1998) |
| PO8064 | 15-Jul-97 | Image Creation Method and Apparatus | 6,312,107 |
| | | (IJ30) | (Jul. 10, 1998) |
| PO9389 | 23-Sep-97 | Image Creation Method and Apparatus | 6,227,653 |
| | | (IJ31) | (Jul. 10, 1998) |
| PO9391 | 23-Sep-97 | Image Creation Method and Apparatus | 6,234,609 |
| | | (IJ32) | (Jul. 10, 1998) |
| PP0888 | 12-Dec-97 | Image Creation Method and Apparatus | 6,238,040 |
| | | (IJ33) | (Jul. 10, 1998) |
| PP0891 | 12-Dec-97 | Image Creation Method and Apparatus | 6,188,415 |
| | | (IJ34) | (Jul. 10, 1998) |
| PP0890 | 12-Dec-97 | Image Creation Method and Apparatus | 6,227,654 |
| | | (IJ35) | (Jul. 10, 1998) |
| PP0873 | 12-Dec-97 | Image Creation Method and Apparatus | 6,209,989 |
| | | (IJ36) | (Jul. 10, 1998) |
| PP0993 | 12-Dec-97 | Image Creation Method and Apparatus | 6,247,791 |
| | | (IJ37) | (Jul. 10, 1998) |
| PP0890 | 12-Dec-97 | Image Creation Method and Apparatus | 6,336,710 |
| | | (IJ38) | (Jul. 10, 1998) |
| PP1398 | 19-Jan-98 | An Image Creation Method and | 6,217,153 |
| | | Apparatus (IJ39) | (Jul. 10, 1998) |
| PP2592 | 25-Mar-98 | An Image Creation Method and | 6,416,167 |
| | | Apparatus (IJ40) | (Jul. 10, 1998) |
| PP2593 | 25-Mar-98 | Image Creation Method and Apparatus | 6,243,113 |
| | | (IJ41) | (Jul. 10, 1998) |
| PP3991 | 9-Jun-98 | Image Creation Method and Apparatus | 6,283,581 |
| | | (IJ42) | (Jul. 10, 1998) |
| PP3987 | 9-Jun-98 | Image Creation Method and Apparatus | 6,247,790 |
| | | (IJ43) | (Jul. 10, 1998) |
| PP3985 | 9-Jun-98 | Image Creation Method and Apparatus | 6,260,953 |
| | | (IJ44) | (Jul. 10, 1998) |
| PP3983 | 9-Jun-98 | Image Creation Method and Apparatus | 6,267,469 |
| | | (IJ45) | (Jul. 10, 1998) |

### Ink Jet Manufacturing

Further, the present application may utilize advanced semiconductor fabrication techniques in the construction of large arrays of ink jet printers. Suitable manufacturing techniques are described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application and Filing |
| Number | Filing Date | Title | Date |
| PO7935 | 15-Jul-97 | A Method of Manufacture of an Image | 6,224,780 |
| | | Creation Apparatus (IJM01) | (Jul. 10, 1998) |
| PO7936 | 15-Jul-97 | A Method of Manufacture of an Image | 6,235,212 |
| | | Creation Apparatus (IJM02) | (Jul. 10, 1998) |
| PO7937 | 15-Jul-97 | A Method of Manufacture of an Image | 6,280,643 |
| | | Creation Apparatus (IJM03) | (Jul. 10, 1998) |
| PO8061 | 15-Jul-97 | A Method of Manufacture of an Image | 6,284,147 |
| | | Creation Apparatus (IJM04) | (Jul. 10, 1998) |
| PO8054 | 15-Jul-97 | A Method of Manufacture of an Image | 6,214,244 |
| | | Creation Apparatus (IJM05) | (Jul. 10, 1998) |
| PO8065 | 15-Jul-97 | A Method of Manufacture of an Image | 6,071,750 |
| | | Creation Apparatus (IJM06) | (Jul. 10, 1998) |
| PO8055 | 15-Jul-97 | A Method of Manufacture of an Image | 6,267,905 |
| | | Creation Apparatus (IJM07) | (Jul. 10, 1998) |
| PO8053 | 15-Jul-97 | A Method of Manufacture of an Image | 6,251,298 |
| | | Creation Apparatus (IJM08) | (Jul. 10, 1998) |
| PO8078 | 15-Jul-97 | A Method of Manufacture of an Image | 6,258,285 |
| | | Creation Apparatus (IJM09) | (Jul. 10, 1998) |
| PO7933 | 15-Jul-97 | A Method of Manufacture of an Image | 6,225,138 |
| | | Creation Apparatus (IJM10) | (Jul. 10, 1998) |
| PO7950 | 15-Jul-97 | A Method of Manufacture of an Image | 6,241,904 |
| | | Creation Apparatus (IJM11) | (Jul. 10, 1998) |
| PO7949 | 15-Jul-97 | A Method of Manufacture of an Image | 6,299,786 |
| | | Creation Apparatus (IJM12) | (Jul. 10, 1998) |
| PO8060 | 15-Jul-97 | A Method of Manufacture of an Image | 09/113,124 |
| | | Creation Apparatus (IJM13) | (Jul. 10, 1998) |
| PO8059 | 15-Jul-97 | A Method of Manufacture of an Image | 6,231,773 |
| | | Creation Apparatus (IJM14) | (Jul. 10, 1998) |
| PO8073 | 15-Jul-97 | A Method of Manufacture of an Image | 6,190,931 |
| | | Creation Apparatus (IJM15) | (Jul. 10, 1998) |
| PO8076 | 15-Jul-97 | A Method of Manufacture of an Image | 6,248,249 |
| | | Creation Apparatus (IJM16) | (Jul. 10, 1998) |
| PO8075 | 15-Jul-97 | A Method of Manufacture of an Image | 6,290,862 |
| | | Creation Apparatus (IJM17) | (Jul. 10, 1998) |
| PO8079 | 15-Jul-97 | A Method of Manufacture of an Image | 6,241,906 |
| | | Creation Apparatus (IJM18) | (Jul. 10, 1998) |
| PO8050 | 15-Jul-97 | A Method of Manufacture of an Image | 09/113,116 |
| | | Creation Apparatus (IJM19) | (Jul. 10, 1998) |
| PO8052 | 15-Jul-97 | A Method of Manufacture of an Image | 6,241,905 |
| | | Creation Apparatus (IJM20) | (Jul. 10, 1998) |
| PO7948 | 15-Jul-97 | A Method of Manufacture of an Image | 6,451,216 |
| | | Creation Apparatus (IJM21) | (Jul. 10, 1998) |
| PO7951 | 15-Jul-97 | A Method of Manufacture of an Image | 6,231,772 |
| | | Creation Apparatus (IJM22) | (Jul. 10, 1998) |
| PO8074 | 15-Jul-97 | A Method of Manufacture of an Image | 6,274,056 |
| | | Creation Apparatus (IJM23) | (Jul. 10, 1998) |
| PO7941 | 15-Jul-97 | A Method of Manufacture of an Image | 6,290,861 |
| | | Creation Apparatus (IJM24) | (Jul. 10, 1998) |
| PO8077 | 15-Jul-97 | A Method of Manufacture of an Image | 6,248,248 |
| | | Creation Apparatus (IJM25) | (Jul. 10, 1998) |
| PO8058 | 15-Jul-97 | A Method of Manufacture of an Image | 6,306,671 |
| | | Creation Apparatus (IJM26) | (Jul. 10, 1998) |
| PO8051 | 15-Jul-97 | A Method of Manufacture of an Image | 6,331,258 |
| | | Creation Apparatus (IJM27) | (Jul. 10, 1998) |
| PO8045 | 15-Jul-97 | A Method of Manufacture of an Image | 6,110,754 |
| | | Creation Apparatus (IJM28) | (Jul. 10, 1998) |
| PO7952 | 15-Jul-97 | A Method of Manufacture of an Image | 6,294,101 |
| | | Creation Apparatus (IJM29) | (Jul. 10, 1998) |
| PO8046 | 15-Jul-97 | A Method of Manufacture of an Image | 6,416,679 |
| | | Creation Apparatus (IJM30) | (Jul. 10, 1998) |
| PO8503 | 11-Aug-97 | A Method of Manufacture of an Image | 6,264,849 |
| | | Creation Apparatus (IJM30a) | (Jul. 10, 1998) |
| PO9390 | 23-Sep-97 | A Method of Manufacture of an Image | 6,254,793 |
| | | Creation Apparatus (IJM31) | (Jul. 10, 1998) |
| PO9392 | 23-Sep-97 | A Method of Manufacture of an Image | 6,235,211 |
| | | Creation Apparatus (IJM32) | (Jul. 10, 1998) |
| PP0889 | 12-Dec-97 | A Method of Manufacture of an Image | 6,235,211 |
| | | Creation Apparatus (IJM35) | (Jul. 10, 1998) |
| PP0887 | 12-Dec-97 | A Method of Manufacture of an Image | 6,264,850 |
| | | Creation Apparatus (IJM36) | (Jul. 10, 1998) |
| PP0882 | 12-Dec-97 | A Method of Manufacture of an Image | 6,258,284 |
| | | Creation Apparatus (IJM37) | (Jul. 10, 1998) |
| PP0874 | 12-Dec-97 | A Method of Manufacture of an Image | 6,258,284 |
| | | Creation Apparatus (IJM38) | (Jul. 10, 1998) |
| PP1396 | 19-Jan-98 | A Method of Manufacture of an Image | 6,228,668 |
| | | Creation Apparatus (IJM39) | (Jul. 10, 1998) |
| PP2591 | 25-Mar-98 | A Method of Manufacture of an Image | 6,180,427 |
| | | Creation Apparatus (IJM41) | (Jul. 10, 1998) |
| PP3989 | 9-Jun-98 | A Method of Manufacture of an Image | 6,171,875 |
| | | Creation Apparatus (IJM40) | (Jul. 10, 1998) |
| PP3990 | 9-Jun-98 | A Method of Manufacture of an Image | 6,267,904 |
| | | Creation Apparatus (IJM42) | (Jul. 10, 1998) |
| PP3986 | 9-Jun-98 | A Method of Manufacture of an Image | 6,245,247 |
| | | Creation Apparatus (IJM43) | (Jul. 10, 1998) |
| PP3984 | 9-Jun-98 | A Method of Manufacture of an Image | 6,245,247 |
| | | Creation Apparatus (IJM44) | (Jul. 10, 1998) |
| PP3982 | 9-Jun-98 | A Method of Manufacture of an Image | 6,231,148 |
| | | Creation Apparatus (IJM45) | (Jul. 10, 1998) |

### Fluid Supply

Further, the present application may utilize an ink delivery system to the ink jet head. Delivery systems relating to the supply of ink to a series of ink jet nozzles are described in the following Australian provisional patent specifications, the disclosure of which are hereby incorporated by cross-reference. The serial numbers of respective corresponding US patent applications are also provided for the sake of convenience.

| Australian | | | US Patent/ |
|---|---|---|---|
| Provisional | | | Patent Application |
| Number | Filing Date | Title | and Filing Date |
| PO8003 | 15-Jul-97 | Supply Method and | 6,350,023 |
| | | Apparatus (F1) | (Jul. 10, 1998) |
| PO8005 | 15-Jul-97 | Supply Method and | 6,318,849 |
| | | Apparatus (F2) | (Jul. 10, 1998) |
| PO9404 | 23-Sep-97 | A Device and | 09/113,101 |
| | | Method (F3) | (Jul. 10, 1998) |

### MEMS Technology

Further, the present application may utilize advanced semiconductor microelectromechanical techniques in the construction of large arrays of ink jet printers. Suitable microelectromechanical techniques are described in the following Australian provisional patent specifications incorporated here by cross-reference. The serial numbers of respective corresponding US patent applications are also provided for the sake of convenience.

| Australian | | | US Patent/ |
|---|---|---|---|
| Provisional | | | Patent Application |
| Number | Filing Date | Title | and Filing Date |
| PO7943 | 15-Jul-97 | A device (MEMS01) | |
| PO8006 | 15-Jul-97 | A device (MEMS02) | 6,087,638 |
| | | | (Jul. 10, 1998) |
| PO8007 | 15-Jul-97 | A device (MEMS03) | 09/113,093 |
| | | | (Jul. 10, 1998) |
| PO8008 | 15-Jul-97 | A device (MEMS04) | 6,340,222 |
| | | | (Jul. 10, 1998) |
| PO8010 | 15-Jul-97 | A device (MEMS05) | 6,041,600 |
| | | | (Jul. 10, 1998) |
| PO8011 | 15-Jul-97 | A device (MEMS06) | 6,299,300 |
| | | | (Jul. 10, 1998) |
| PO7947 | 15-Jul-97 | A device (MEMS07) | 6,067,797 |
| | | | (Jul. 10, 1998) |
| PO7945 | 15-Jul-97 | A device (MEMS08) | 09/113,081 |
| | | | (Jul. 10, 1998) |
| PO7944 | 15-Jul-97 | A device (MEMS09) | 6,286,935 |
| | | | (Jul. 10, 1998) |
| PO7946 | 15-Jul-97 | A device (MEMS10) | 6,044,646 |
| | | | (Jul. 10, 1998) |
| PO9393 | 23-Sep-97 | A Device and Method | 09/113,065 |
| | | (MEMS11) | (Jul. 10, 1998) |
| PP0875 | 12-Dec-97 | A Device (MEMS12) | 09/113,078 |
| | | | (Jul. 10, 1998) |
| PP0894 | 12-Dec-97 | A Device and Method | 09/113,075 |
| | | (MEMS13) | (Jul. 10, 1998) |

### IR Technologies

Further, the present application may include the utilization of a disposable camera system such as those described in the following Australian provisional patent specifications incorporated here by cross-reference. The serial numbers of respective corresponding US patent applications are also provided for the sake of convenience.

| Australian | | | US Patent/ |
|---|---|---|---|
| Provisional | | | Patent Application |
| Number | Filing Date | Title | and Filing Date |
| PP0895 | 12-Dec-97 | An Image Creation Method and | 6,231,148 |
| | | Apparatus (IR01) | (Jul. 10, 1998) |
| PP0870 | 12-Dec-97 | A Device and Method (IR02) | 09/113,106 |
| | | | (Jul. 10, 1998) |
| PP0869 | 12-Dec-97 | A Device and Method (IR04) | 6,293,658 |
| | | | (Jul. 10, 1998) |
| PP0887 | 12-Dec-97 | Image Creation Method and | 09/113,104 |
| | | Apparatus (IR05) | (Jul. 10, 1998) |
| PP0885 | 12-Dec-97 | An Image Production System (IR06) | 6,238,033 |
| | | | (Jul. 10, 1998) |
| PP0884 | 12-Dec-97 | Image Creation Method and | 6,312,070 |
| | | Apparatus (IR10) | (Jul. 10, 1998) |
| PP0886 | 12-Dec-97 | Image Creation Method and | 6,238,111 |
| | | Apparatus (IR12) | (Jul. 10, 1998) |
| PP0871 | 12-Dec-97 | A Device and Method (IR13) | 09/113,086 |
| | | | (Jul. 10, 1998) |
| PP0876 | 12-Dec-97 | An Image Processing Method and | 09/113,094 |
| | | Apparatus (IR14) | (Jul. 10, 1998) |
| PP0877 | 12-Dec-97 | A Device and Method (IR16) | 6,378,970 |
| | | | (Jul. 10, 1998 |
| PP0878 | 12-Dec-97 | A Device and Method (IR17) | 6,196,739 |
| | | | (Jul. 10, 1998) |
| PP0879 | 12-Dec-97 | A Device and Method (IR18) | 09/112,774 |
| | | | (Jul. 10, 1998) |
| PP0883 | 12-Dec-97 | A Device and Method (IR19) | 6,270,182 |
| | | | (Jul. 10, 1998) |
| PP0880 | 12-Dec-97 | A Device and Method (IR20) | 6,152,619 |
| | | | (Jul. 10, 1998) |
| PP0881 | 12-Dec-97 | A Device and Method (IR21) | 09/113,092 |
| | | | (Jul. 10, 1998) |

### DotCard Technologies

Further, the present application may include the utilization of a data distribution system such as that described in the following Australian provisional patent specifications incorporated here by cross-reference. The serial numbers of respective corresponding US patent applications are also provided for the sake of convenience.

| Australian | | | US Patent/ |
|---|---|---|---|
| Provisional | | | Patent Application |
| Number | Filing Date | Title | and Filing Date |
| PP2370 | 16-Mar-98 | Data Processing | 09/112,781 |
| | | Method and | (Jul. 10, 1998) |
| | | Apparatus (Dot01) | |
| PP2371 | 16-Mar-98 | Data Processing | 09/113,052 |
| | | Method and | (Jul. 10, 1998 |
| | | Apparatus (Dot02) | |

Artcam Technologies Further, the present application may include the utilization of camera and data processing techniques such as an Artcam type device as described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application and Filing |
| Number | Filing Date | Title | Date |
| PO7991 | 15-Jul-97 | Image Processing Method and | 09/113,060 |
| | | Apparatus (ART01) | (Jul. 10, 1998) |
| PO7988 | 15-Jul-97 | Image Processing Method and | 6,476,863 |
| | | Apparatus (ART02) | (Jul. 10, 1998) |
| PO7993 | 15-Jul-97 | Image Processing Method and | 09/113,073 |
| | | Apparatus (ART03) | (Jul. 10, 1998) |
| PO9395 | 23-Sep-97 | Data Processing Method and | 6,322,181 |
| | | Apparatus (ART04) | (Jul. 10, 1998) |
| PO8017 | 15-Jul-97 | Image Processing Method and | 09/112,747 |
| | | Apparatus (ART06) | (Jul. 10, 1998) |
| PO8014 | 15-Jul-97 | Media Device (ART07) | 6,227,648 |
| | | | (Jul. 10, 1998) |
| PO8025 | 15-Jul-97 | Image Processing Method and | 09/112,750 |
| | | Apparatus (ART08) | (Jul. 10, 1998) |
| PO8032 | 15-Jul-97 | Image Processing Method and | 09/112,746 |
| | | Apparatus (ART09) | (Jul. 10, 1998) |
| PO7999 | 15-Jul-97 | Image Processing Method and | 09/112,743 |
| | | Apparatus (ART10) | (Jul. 10, 1998) |
| PO7998 | 15-Jul-97 | Image Processing Method and | 09/112,742 |
| | | Apparatus (ART11) | (Jul. 10, 1998) |
| PO8031 | 15-Jul-97 | Image Processing Method and | 09/112,741 |
| | | Apparatus (ART12) | (Jul. 10, 1998) |
| PO8030 | 15-Jul-97 | Media Device (ART13) | 6,196,541 |
| | | | (Jul. 10, 1998) |
| PO7997 | 15-Jul-97 | Media Device (ART15) | 6,195,150 |
| | | | (Jul. 10, 1998) |
| PO7979 | 15-Jul-97 | Media Device (ART16) | 6,362,868 |
| | | | (Jul. 10, 1998) |
| PO8015 | 15-Jul-97 | Media Device (ART17) | 09/112,738 |
| | | | (Jul. 10, 1998) |
| PO7978 | 15-Jul-97 | Media Device (ART18) | 09/113,067 |
| | | | (Jul. 10, 1998) |
| PO7982 | 15-Jul-97 | Data Processing Method and | 6,431,669 |
| | | Apparatus (ART19) | (Jul. 10, 1998 |
| PO7989 | 15-Jul-97 | Data Processing Method and | 6,362,869 |
| | | Apparatus (ART20) | (Jul. 10, 1998 |
| PO8019 | 15-Jul-97 | Media Processing Method and | 6,472,052 |
| | | Apparatus (ART21) | (Jul. 10, 1998 |
| PO7980 | 15-Jul-97 | Image Processing Method and | 6,356,715 |
| | | Apparatus (ART22) | (Jul. 10, 1998) |
| PO8018 | 15-Jul-97 | Image Processing Method and | 09/112,777 |
| | | Apparatus (ART24) | (Jul. 10, 1998) |
| PO7938 | 15-Jul-97 | Image Processing Method and | 09/113,224 |
| | | Apparatus (ART25) | (Jul. 10, 1998) |
| PO8016 | 15-Jul-97 | Image Processing Method and | 6,366,693 |
| | | Apparatus (ART26) | (Jul. 10, 1998) |
| PO8024 | 15-Jul-97 | Image Processing Method and | 6,329,990 |
| | | Apparatus (ART27) | (Jul. 10, 1998) |
| PO7940 | 15-Jul-97 | Data Processing Method and | 09/113,072 |
| | | Apparatus (ART28) | (Jul. 10, 1998) |
| PO7939 | 15-Jul-97 | Data Processing Method and | 09/112,785 |
| | | Apparatus (ART29) | (Jul. 10, 1998) |
| PO8501 | 11-Aug-97 | Image Processing Method and | 6,137,500 |
| | | Apparatus (ART30) | (Jul. 10, 1998) |
| PO8500 | 11-Aug-97 | Image Processing Method and | 09/112,796 |
| | | Apparatus (ART31) | (Jul. 10, 1998) |
| PO7987 | 15-Jul-97 | Data Processing Method and | 09/113,071 |
| | | Apparatus (ART32) | (Jul. 10, 1998) |
| PO8022 | 15-Jul-97 | Image Processing Method and | 6,398,328 |
| | | Apparatus (ART33) | (Jul. 10, 1998 |
| PO8497 | 11-Aug-97 | Image Processing Method and | 09/113,090 |
| | | Apparatus (ART34) | (Jul. 10, 1998) |
| PO8020 | 15-Jul-97 | Data Processing Method and | 6,431,704 |
| | | Apparatus (ART38) | (Jul. 10, 1998 |
| PO8023 | 15-Jul-97 | Data Processing Method and | 09/113,222 |
| | | Apparatus (ART39) | (Jul. 10, 1998) |
| PO8504 | 11-Aug-97 | Image Processing Method and | 09/112,786 |
| | | Apparatus (ART42) | (Jul. 10, 1998) |
| PO8000 | 15-Jul-97 | Data Processing Method and | 6,415,054 |
| | | Apparatus (ART43) | (Jul. 10, 1998) |
| PO7977 | 15-Jul-97 | Data Processing Method and | 09/112,782 |
| | | Apparatus (ART44) | (Jul. 10, 1998) |
| PO7934 | 15-Jul-97 | Data Processing Method and | 09/113,056 |
| | | Apparatus (ART45) | (Jul. 10, 1998) |
| PO7990 | 15-Jul-97 | Data Processing Method and | 09/113,059 |
| | | Apparatus (ART46) | (Jul. 10, 1998) |
| PO8499 | 11-Aug-97 | Image Processing Method and | 6,486,886 |
| | | Apparatus (ART47) | (Jul. 10, 1998) |
| PO8502 | 11-Aug-97 | Image Processing Method and | 6,381,361 |
| | | Apparatus (ART48) | (Jul. 10, 1998) |
| PO7981 | 15-Jul-97 | Data Processing Method and | 6,317,192 |
| | | Apparatus (ART50) | (Jul. 10, 1998 |
| PO7986 | 15-Jul-97 | Data Processing Method and | 09/113,057 |
| | | Apparatus (ART51) | (Jul. 10, 1998) |
| PO7983 | 15-Jul-97 | Data Processing Method and | 09/113,054 |
| | | Apparatus (ART52) | (Jul. 10, 1998) |
| PO8026 | 15-Jul-97 | Image Processing Method and | 09/112,752 |
| | | Apparatus (ART53) | (Jul. 10, 1998) |
| PO8027 | 15-Jul-97 | Image Processing Method and | 09/112,759 |
| | | Apparatus (ART54) | (Jul. 10, 1998) |
| PO8028 | 15-Jul-97 | Image Processing Method and | 09/112,757 |
| | | Apparatus (ART56) | (Jul. 10, 1998) |
| PO9394 | 23-Sep-97 | Image Processing Method and | 6,357,135 |
| | | Apparatus (ART57) | (Jul. 10, 1998 |
| PO9396 | 23-Sep-97 | Data Processing Method and | 09/113,107 |
| | | Apparatus (ART58) | (Jul. 10, 1998) |
| PO9397 | 23-Sep-97 | Data Processing Method and | 6,271,931 |
| | | Apparatus (ART59) | (Jul. 10, 1998) |
| PO9398 | 23-Sep-97 | Data Processing Method and | 6,353,772 |
| | | Apparatus (ART60) | (Jul. 10, 1998) |
| PO9399 | 23-Sep-97 | Data Processing Method and | 6,106,147 |
| | | Apparatus (ART61) | (Jul. 10, 1998) |
| PO9400 | 23-Sep-97 | Data Processing Method and | 09/112,790 |
| | | Apparatus (ART62) | (Jul. 10, 1998) |
| PO9401 | 23-Sep-97 | Data Processing Method and | 6,304,291 |
| | | Apparatus (ART63) | (Jul. 10, 1998) |
| PO9402 | 23-Sep-97 | Data Processing Method and | 09/112,788 |
| | | Apparatus (ART64) | (Jul. 10, 1998) |
| PO9403 | 23-Sep-97 | Data Processing Method and | 6,305,770 |
| | | Apparatus (ART65) | (Jul. 10, 1998) |
| PO9405 | 23-Sep-97 | Data Processing Method and | 6,289,262 |
| | | Apparatus (ART66) | (Jul. 10, 1998) |
| PP0959 | 16-Dec-97 | A Data Processing Method and | 6,315,200 |
| | | Apparatus (ART68) | (Jul. 10, 1998) |
| PP1397 | 19-Jan-98 | A Media Device (ART69) | 6,217,165 |
| | | | (Jul. 10, 1998) |

1. A pagewidth inkjet printer comprising:
a printhead with a nozzle surface and a surrounding surface that surrounds the nozzle surface;
a platen that partially defines a media path extending passed the printhead;
a capping member for sealing engagement with the surrounding surface;
a solenoid for moving the capping member in a direction perpendicular to the longitudinal extent of the nozzle surface; wherein during use,
the printhead, the media path and the platen all remain fixed relative to each other, and the capping member is movable through the media path.

2. A pagewidth inkjet printer according to claim 1 wherein the printhead is provided as a cartridge configured for removal and replacement.

3. A pagewidth inkjet printer according to claim 2 wherein the cartridge has a supply of ink for the printhead and a supply of media.

4. A pagewidth inkjet printer according to claim 3 wherein the nozzle surface is a nozzle array on an external surface of a pagewidth printhead integrated circuit (IC).

5. A pagewidth inkjet printer according to claim 1 wherein the capping member has a seal for sealing engagement with the surrounding surface and a blotter of porous material surrounded by the seal.

6. A pagewidth inkjet printer according to claim 3 wherein the surrounding surface is part of a plastic component that is injection moulded such that the surrounding surface has a predetermined surface roughness.

7. A pagewidth inkjet printer according to claim 6 wherein the surrounding surface has a recess for receiving the printhead IC such that the plastic component has integrally formed ink stores for the printhead IC.

8. A pagewidth inkjet printer according to claim 7 wherein the recess is dimensioned such that the nozzle surface is substantially flush with the surrounding surface.

9. A pagewidth inkjet printer according to claim 8 wherein the capping member is biased into sealing engagement with the surface surrounding the nozzle surface.
